(19) United States
(12) Patent Application Publication
(10) Pub. No.: US 2010/0087561 A1
(43) Pub. Date: Apr. 8, 2010

(54) VISCOELASTIC POLYURETHANE FOAMS COMPRISING AMIDATED OR TRANSESTERIFIED OLIGOMERIC NATURAL OIL POLYOLS

(75) Inventors: Timothy Walter Abraham, Minnetonka, MN (US); Dzung G. Dai, Maple Grove, MN (US); Ricardo De Genova, Edina, MN (US); Jeff Malsam, Minneapolis, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/514,893

(22) PCT Filed: Nov. 16, 2007
(86) PCT No.: PCT/US2007/024195

§ 371 Date: May 14, 2009

Related U.S. Application Data
(60) Provisional application No. 60/859,337, filed on Nov. 16, 2006.

(51) Int. Cl. C08J 9/00

(52) U.S. Cl. 521/170

(57) ABSTRACT

Described are viscoelastic polyurethane foams that comprise the reaction product of a polyisocyanate and an active-hydrogen composition comprising an amidated or transesterified oligomeric natural oil polyol.

### CROSS-REFERENCE TO RELATED APPLICATIONS

This application claims the benefit of U.S. Provisional Application Ser. No. 60/859,337, filed Nov. 16, 2006, the disclosure of which is incorporated herein by reference.

### BACKGROUND

Viscoelastic foams make up a special grade of polyurethane foams that are characterized by displaying a low rate of recovery from an applied force and low resilience (i.e., high viscous damping) as measured, for example, by the ball rebound test. Viscoelastic foams typically have ball rebound values of less than about 20%, as compared to about 40% for conventional slabstock foams, and about 55-60% for high resilience foams. Because of their unique properties, viscoelastic foams have been used in many specialty applications such as pillows, mattresses, airplane seats, headphones, ski boots, hiking boots, packaging, helmet liners, gym mats, ear plugs and NVH (noise, vibration and harshness applications).

Many known viscoelastic polyurethane foams formulations comprise a polyisocyanate and an active-hydrogen composition that comprises one or more polyols that are derived from petroleum feedstocks. For example, viscoelastic polyurethane foams based on polyester polyols are known. With the high cost of petroleum feedstocks, there is a growing need to provide new viscoelastic polyurethane formulations that include renewable materials such as natural oil-based polyols. In view of the foregoing, what is desired is a viscoelastic polyurethane foam that comprises natural oil-derived polyols.

### SUMMARY

The present invention provides viscoelastic polyurethane foam comprising the reaction product of: (a) a polyisocyanate; and (b) an active-hydrogen composition comprising an amidated or transesterified oligomeric natural oil polyol.

Amidated or transesterified oligomeric natural oil polyols that are useful in the viscoelastic foams of the invention may be prepared by first forming an oligomeric natural oil and then amidating or transesterifying the oligomeric natural oil with a polyamine compound (amidation) or with a polyol compound (transesterification). Also useful are alkanolamines.

In many embodiments, the amidated or transesterified oligomeric natural oil polyol may be formed by the process of: (a) providing a natural oil; (b) oligomerizing the natural oil to form an oligomeric natural oil; and (c) amidating or transesterifying the oligomeric natural oil with a polyamine (e.g., diamine) compound, or with a polyol (e.g, diol) compound to form the amidated or transesterified oligomeric natural oil polyol.

Oligomerization of the natural oil may be accomplished by chemical oligomerization techniques (e.g., epoxidation and ring opening oligomerization) or by thermal oligomerization techniques. Examples of natural oils that may be useful as starting materials include plant-based oils (e.g., vegetable oils) and animal fats. Examples of plant-based oils include soybean oil, safflower oil, linseed oil, corn oil, sunflower oil, olive oil, canola oil, sesame oil, cottonseed oil, palm oil, rapeseed oil, tung oil, peanut oil, and combinations thereof. Examples of animal fats include fish oil, lard, and tallow.

After oligomerization, the oligomeric natural oil is amidated or transesterified to form the polyol. Amidation involves reacting the oligomeric natural oil with a polyamine (e.g., diamine) compound. During amidation, at least a portion of the amine groups that are present in the polyamine react with at least a portion of the ester groups that are present in the oligomeric natural oil resulting in the formation of amide groups and hydroxyl groups. The formation of hydroxyl groups causes the oligomeric natural oil to be converted into an amidated oligomeric natural oil polyol suitable for use in a viscoelastic polyurethane foam.

Transesterification involves reacting the oligomeric natural oil with a polyol (e.g., diol) compound. During transesterification, at least a portion of the ester groups that are present in the polyol compound react with at least a portion of the ester groups that are present in the oligomeric natural oil resulting in the formation of ester groups and hydroxyl groups. The formation of the hydroxyl groups causes the oligomeric natural oil to be converted into a transesterified oligomeric natural oil polyol suitable for use in a viscoelastic polyurethane foam.

In some embodiments, the polyamines useful for amidation are diamine compounds that can be represented by the formula:

H₂N—R—NH₂

where R is an organic group such as an aliphatic group or aromatic group. Representative examples of useful diamines include polyalkylene glycol diamines such as polybutylene glycol diamines, polypropylene glycol diamines, polyethylene glycol diamines, and mixtures thereof.

In some embodiments, the diamine is an amine-terminated polypropylene glycol diamine and is represented by the formula:

H₂N—[—CH(—CH₃)—CH₂—O—]ₓ—CH₂—CH(—CH₃)—NH₂;
where x ranges from about 2 to about 70.

In other embodiments, the diamine compound comprises a polyalkylene glycol diamine. For example, the polyalkylene glycol diamines may be represented by the formula:

H₂N—CH(—CH₃)—CH₂—[—O—CH₂—CH(—CH₃)—]ₓ—[O—CH₂—CH₂—]_{y}—[—O—CH₂—CH(—CH₃)—]_{z}—NH₂
where y is about 2 to about 40; and
(x+z) is about 1 to about 6.

In other embodiments, the diamine compound is represented by the formula:

H₂N—(CH₂)ₓ—O—CH₂—CH₂—O—(CH₂)ₓ—NH₂
where x ranges from about 2 to 3.

In many embodiments, the polyamine compound is present in an amount ranging from about 0.1 mole % to about 50 mole % of the oligomerized natural oil.

For transesterification, useful diol compounds include ethylene glycol, propylene glycol, 1,3-propanediol, 1,4-butanediol, pentanediols, hexanediols, and the like, and mixtures thereof. Also useful are polyethylene, polypropylene and polybutylene glycols of various lengths. Also useful are alkanolamines which may participate in amidation, transesterification, or both amidation and transesterification. Reactivity of alkanolamines depends upon the structure and reactivity of the particular alkanolamine that is used.

In many embodiments, the amidated or transesterified oligomeric natural oil polyol has a number average molecular weight (Mn) ranging from about 1000 grams/mole to about 5000 grams/mole and weight average molecular weight (Mw) ranging from about 2000 to about 50,000 grams/mole. The amidated or transesterified oligomeric natural oil polyol typically has a number average hydroxyl functionality (Fn) of about 1.6 or greater.

In many embodiments, the viscoelastic foams of the invention are characterized by having low resiliency, for example, as measured by the ball rebound test. Typically, the resiliency of the polyurethane foams will be about 20% or less, about 10% or less, about 5% or less, or about 1% or less. Viscoelastic foams of the invention typically have a glass transition temperature (Tg), as measured by Dynamic Mechanical Analysis (DMA), that is near room temperature, for example, ranging from about −40° C. to about +40° C.

In many embodiments, the viscoelastic foams of the invention retain their viscoelastic nature at low temperatures. This allows the viscoelastic foams of the invention to be used in low temperature applications. The improved low temperature properties of the foams may be characterized by dynamic mechanical analysis (DMA). For example, in some embodiments, the viscoelastic foams have a storage modulus (G′) of 77.4 MPa or less at −30° C. In some embodiments the viscoelastic foams have a loss modulus (G″) of about 334.32 MPa or less at −30° C. (for 5 lb/ft³ foam density).

Throughout the application, the following terms will have the following meanings.

As used herein “polyol” refers to a molecule that has an average of greater than 1.0 hydroxyl groups per molecule. It may optionally include other functionalities.

As used herein “thermally oligomerized” refers to a natural oil that has been oligomerized by the application of heat.

As used herein “chemically oligomerized” refers to a natural oil that has been oligomerized by a chemical reaction.

As used herein “natural oil” means a plant-based oil or an animal fat.

As used herein “oligomer” refers to two or more glyceride-based fatty acid ester monomer units that have been covalently bonded to one another by an oligomerizing reaction. Oligomers include dimers, trimers, tetramers, and higher order oligomers. The term “oligimerized” refers to a material that comprises oligomers.

As used herein “active-hydrogen composition” refers to a composition that comprises reactants having hydrogen atom-containing groups that are capable of reacting with isocyanate groups. Examples of hydrogen atom containing-groups include alcohols (e.g., polyols), amines (e.g., polyamines), and water.

As used herein “petroleum-derived polyol” refers to a polyol manufactured from a petroleum feedstock.

As used herein “viscoelastic” refers to polyurethane foams that display a slow rate of return after deformation (i.e., high hysteresis), a low resilience value, or both.

As used herein the term “polyurethane foam” refers to cellular products obtained by reacting a polyisocyanate with an active hydrogen composition, using foaming agents, and in particular includes cellular products obtained with water as reactive foaming agent (involving a reaction of water with isocyanate groups yielding urea linkages and carbon dioxide and producing polyurea-urethane foams)

### BRIEF DESCRIPTION OF THE DRAWINGS

FIGS. 1-24 are dynamic mechanical analysis (DMA) curves for various polyurethane foam samples as described herein.

### DETAILED DESCRIPTION

The invention relates to viscoelastic polyurethane foams comprising the reaction product of a polyisocyanate and an active-hydrogen composition comprising an amidated or transesterified oligomeric natural oil polyol. Examples include (a) amidated thermally oligomerized polyols; (b) amidated chemically oligomerized polyols; (c) transesterified thermally oligomerized polyols; and (d) transesterified chemically oligomerized polyols.

In order to make the amidated or transesterified natural oil polyol, a starting composition comprising a natural oil is first oligomerized by chemical oligomerization or by thermal oligomerization. After oligomerization, the oligomeric natural oil is amidated using a polyamine compound (e.g., a diamine) or is transesterified using a polyol (e.g., a diol) compound. Suitable amidated or transesterified natural oil polyols may be prepared by a process comprising the steps of: (a) providing a natural oil; (b) chemically or thermally oligomerizing the natural oil to form an oligomeric natural oil; (c) amidating or transesterifying the oligomeric natural oil to form an amidated or transesterified oligomeric natural oil polyol.

In a preferred embodiment, the polyol is an amidated thermally oligomerized natural oil polyol. Such a polyol may be made by a process comprising the steps of: (a) providing a natural oil; (b) heating the natural oil so that it oligomerizes to form a thermally oligomerized natural oil; and (c) amidating the thermally oligomerized natural oil to form an amidated thermally oligomerized natural oil polyol.

In another embodiment, the polyol is an amidated chemically oligomerized natural oil polyol. Such a polyol may be made by a process comprising the steps of: (a) providing a natural oil; (b) chemically oligomerizing the natural oil so that it oligomerizes to form a chemically oligomerized natural oil; and (c) amidating the chemically oligomerized natural oil to form an amidated chemically oligomerized natural oil polyol.

In another embodiment, the polyol is a transesterified thermally oligomerized natural oil polyol. Such a polyol may be made by a process comprising the steps of: (a) providing a natural oil; (b) heating the natural oil so that it oligomerizes to form a thermally oligomerized natural oil; and (c) transesterifying the thermally oligomerized natural oil to form a transesterified thermally oligomerized natural oil polyol.

In yet another embodiment, the polyol is a transesterified chemically oligomerized natural oil polyol. Such a polyol may be made by a process comprising the steps of: (a) providing a natural oil; (b) chemically oligomerizing the natural oil so that it oligomerizes to form a chemically oligomerized natural oil; and (c) transesterifying the chemically oligomerized natural oil to form a transesterified chemically oligomerized natural oil polyol.

Details of making the polyols and viscoelastic foams of the invention are described below. Useful polyols are also described, for example, in International Application No. PCT/US2007/010252 entitled “Enhanced Oligomeric Polyols and Polymers Made Therefrom”, having an International filing date of Apr. 27, 2007.

### Starting Materials (Natural Oil)

Useful natural oil starting materials for amidated or transesterified oligomeric natural oil polyols include plant-based oils (e.g., vegetable oils) and animal fats. Examples of plant-based oils include soybean oil, safflower oil, linseed oil, corn oil, sunflower oil, olive oil, canola oil, sesame oil, cottonseed oil, palm oil, rapeseed oil, tung oil, peanut oil, and combinations thereof. Examples of animal fats include fish oil, lard, and tallow. Also useful are partially hydrogenated vegetable oils and genetically modified vegetable oils, including high oleic safflower oil, high oleic soybean oil, high oleic peanut oil, high oleic sunflower oil, and high erucic rapeseed oil (crambe oil).

The number of double bonds per molecule in a natural oil may be quantified by the iodine value (IV) of the oil. For example, a vegetable oil having one double bond per molecule corresponds to an iodine value of about 28. Soybean oil typically has about 4.6 double bonds/molecule and has an iodine value of about 127-140. Canola oil typically has about 4.1 double bonds/molecule and has an iodine value of about 115. Typically, iodine values for the vegetable oils will range from about 40 to about 240. In some embodiments, vegetable oils having an iodine value greater than about 80, greater than about 100, or greater than about 110 are used. In some embodiments, vegetable oils having an iodine value less than about 240, less than about 200, or less than about 180 are used.

Useful natural oils comprise triglycerides of fatty acids. The fatty acids may be saturated or unsaturated and may contain chain lengths ranging from about C12 to about C24. Unsaturated fatty acids include monounsaturated and polyunsaturated fatty acids. Common saturated fatty acids include lauric acid (dodecanoic acid), myristic acid (tetradecanoic acid), palmitic acid (hexadecanoic acid), stearic acid (octadecanoic acid), arachidic acid (eicosanoic acid), and lignoceric acid (tetracosanoic acid). Common monounsaturated fatty acids include palmitoleic (a C₁₆ unsaturated acid) and oleic (a C18 unsaturated acid). Common polyunsaturated fatty acids include linoleic acid (a C18 di-unsaturated acid), linolenic acid (a C18 tri-unsaturated acid), and arachidonic acid (a C20 tetra-unsaturated acid). The triglyceride oils comprise fatty acids esters of glycerol where the fatty acids are random distributed on the three sites of the trifunctional glycol molecule. Different triglyceride oils will have different ratios and distributions of these fatty acids. The ratio of fatty acid for a given triglyceride oil will also vary depending upon such factors, for example, as where the crop is grown, maturity of the crop, weather during the growing season, etc. Because of this it is difficult to provide a specific or unique composition for any given triglyceride oil, rather the composition is typically reported as a statistical average. For example, soybean oil contains a mixture of palmitic, stearic acid, oleic acid, linoleic acid, and linolenic acid in the ratio of about 4:11:24:53:8. This translates into an average molecular weight of about 800-880 grams/mole, an average number of double bonds of about 4.4 to about 4.7 per triglyceride, and an iodine value of about 120 to about 140.

### Thermal Oligomerization

In some embodiments, the natural oil starting material is thermally oligomerized to form an oligomeric natural oil. During thermal oligomerization, the carbon-carbon double bonds that are present in the fatty acid portions of the natural oil react with one another to form crosslinks. The crosslinks may be intramolecular (i.e., between fatty acids esterified to the same glycerol molecule) or intermolecular (i.e., between fatty acids esterified to different glycerol molecules). Intermolecular crosslinks result in the formation of oligomers in the thermally oligomerized natural oil, for example, dimers, trimer, tetramers, and higher order oligomers. In order to oligomerize the natural oil, the natural oil is heated under oligomerizing conditions until it reaches the desired degree of oligomerization. For example, the natural oil may be heated at a temperature of between about 100° C. to about 400° C. for a time ranging from about 2 hours to about 24 hours. The temperature and time used will depend on the type of fatty acids that are present in the natural oil and the desired extent of oligomerization. In many embodiments, the natural oil is heated under anaerobic conditions to promote oligomerization. A variety of catalyst can be used to accelerate the rate of reaction and/or perform the oligomerization at low temperatures.

In some embodiments, the thermally oligomerized natural oil will contain residual double bonds. That is, in some embodiments, not all of the double bonds react when the natural oil is oligomerized to form the thermally oligomerized natural oil. The amount of double bonds can be determined by measuring the iodine value of the thermally oligomerized natural oil. The iodine value (IV) for a compound is the amount of iodine that reacts with a sample of a substance, expressed in centigrams iodine (I₂) per gram of substance (eg I₂/gram). The IV of the thermally oligomerized natural oil will typically depend on the IV of the starting natural oil, and also the extent to which the natural oil is oligomerized. For soybean oil, it is typical for the IV to start at about 125-130 and to reach about 90 after thermal oligomerization.

In some embodiments, the thermally oligomerized natural oil has a number average molecular weight (Mn) of about 1500 to about 4000 grams/mole. In some embodiments, the thermally oligomerized natural oil has a weight average molecular weight (Mw) of about 5000 to about 20,000 grams/mole. Typically, the Mn and Mw of the oligomerized natural oil are targeted to be higher than the desired Mn and Mw for the amidated or transesterified oligomeric natural oil polyol. This is because during the amidation or transesterification process the molecular weight tends to decrease as portions of oligomeric natural oil are cleaved off.

Oligomerization of the natural oil causes the viscosity of the natural oil to increase as oligomers are formed. Typically, the thermally oligomerized natural oil will have a viscosity of about 20 Pas or less, more typically about 15 Pas or less, and most typically about 4 to about 12 Pas.

Additional details pertaining to thermally oligomerized natural oils can be found, for example, in the following publications.
(a) Shiina, Hisako. Yukagaku 1982, Volume 31(7): 421-425;
(b) Rhoades, W. F.; Da Valle, A. J. Journal of the American Oil Chemists' Society (1951), 28, 466-468;
(c) Radlove, S. B.; Falkenburg, L. B. Journal of the American Oil Chemists' Society (1948), 25, 1-3;
(d) Wang, Chaohua; Erhan, Sevim, Journal of the American Oil Chemists' Society (1999), 76(10), 1211-1216; and
(e) Erhan, S. Z.; Bagby, M. O. Journal of the American Oil Chemists' Society (1994), 71(11), 1223-6.

### Chemical Oligomerization

In some embodiments the natural oil is chemically oligomerized. Any known method may be used to chemically oligomerize the natural oil. In an exemplary method, oligomerization of a fully or partially epoxidized natural oil is achieved by ring-opening oligomerization as reported, for example, in U.S. Patent Application No. 2006/0041157A1; and in PCT Publication Nos. WO2006/012344A1 and WO2006/116456. Ring-opening oligomerization may be conducted by reacting an epoxidized natural oil with a ring-opener in the presence of a ring-opening acid catalyst. The components are described in more detail below.

The epoxidized natural oils may be partially or fully epoxidized. Partially epoxidized natural oil may include at least about 10%, at least about 20%, at least about 25%, at least about 30%, at least about 35%, at least about 40% or more of the original amount of double bonds present in the oil. The partially epoxidized natural oil may include up to about 90%, up to about 80%, up to about 75%, up to about 70%, up to about 65%, up to about 60%, or fewer of the original amount of double bonds present in the oil. Fully epoxidized natural oil may include up to about 10%, up to about 5%, up to about 2%, up to about 1%, or fewer of the original amount of double bonds present in the oil.

A partially epoxidized or fully epoxidized natural oil may be prepared by a method that comprises reacting a natural oil with a peroxyacid under conditions that convert a portion of or all of the double bonds of the oil to epoxide groups.

Examples of peroxyacids include peroxyformic acid, peroxyacetic acid, trifluoroperoxyacetic acid, benzyloxyperoxyformic acid, 3,5-dinitroperoxybenzoic acid, m-chloroperoxybenzoic acid, and combinations thereof. In some embodiments, peroxyformic acid or peroxyacetic acid are used. The peroxyacids may be added directly to the reaction mixture, or they may be formed in-situ by reacting a hydroperoxide with a corresponding acid such as formic acid, benzoic acid, fatty acids (e.g., oleic acid), or acetic acid. Examples of hydroperoxides that may be used include hydrogen peroxide, tert-butylhydroperoxide, triphenylsilylhydroperooxide, cumylhydroperoxide, and combinations thereof. In an exemplary embodiment, hydrogen peroxide is used. Typically, the amount of acid used to form the peroxyacid ranges from about 0.25 to about 1.0 moles of acid per mole of double bonds in the vegetable oil, more typically ranging from about 0.45 to about 0.55 moles of acid per mole of double bonds in the vegetable oil. Typically, the amount of hydroperoxide used to form the peroxy acid is about 0.5 to about 1.5 moles of hydroperoxide per mole of double bonds in the vegetable oil, more typically about 0.8 to about 1.2 moles of hydroperoxide per mole of double bonds in the vegetable oil.

Typically, an additional acid component is also present in the reaction mixture. Examples of such additional acids include sulfuric acid, toluenesulfonic acid, trifluoroacetic acid, fluoroboric acid, Lewis acids, acidic clays, or acidic ion exchange resins.

Optionally, a solvent may be added to the reaction. Useful solvents include chemically inert solvents, for example, aprotic solvents. These solvents do not include a nucleophile and are non-reactive with acids. Hydrophobic solvents, such as aromatic and aliphatic hydrocarbons, are particularly desirable. Representative examples of suitable solvents include benzene, toluene, xylene, hexane, isohexane, pentane, heptane, and chlorinated solvents (e.g., carbon tetrachloride). In an exemplary embodiment, toluene is used as the solvent. Solvents may be used to reduce the speed of reaction or to reduce the number of side reactions. In general, a solvent also acts as a viscosity reducer for the resulting composition.

Subsequent to the epoxidation reaction, the reaction product may be neutralized. A neutralizing agent may be added to neutralize any remaining acidic components in the reaction product. Suitable neutralizing agents include weak bases, metal bicarbonates, or ion-exchange resins. Examples of neutralizing agents that may be used include ammonia, calcium carbonate, sodium bicarbonate, magnesium carbonate, amines, and resin, as well as aqueous solutions of neutralizing agents. Typically, the neutralizing agent will be an anionic ion-exchange resin. One example of a suitable weakly-basic ion-exchange resin is sold under the trade designation “LEWATIT MP-64” (from Bayer). If a solid neutralizing agent (e.g., ion-exchange resin) is used, the solid neutralizing agent may be removed from the epoxidized vegetable oil by filtration. Alternatively, the reaction mixture may be neutralized by passing the mixture through a neutralization bed containing a resin or other materials. Alternatively, the reaction product may be repeatedly washed to separate and remove the acidic components from the product. In addition, on or more of the processes may be combined in neutralizing the reaction product. For example, the product could be washed, neutralized with a resin material, and then filtered.

Subsequent to the epoxidation reaction, excess solvents may be removed from the reaction product (i.e., fully epoxidized vegetable oil). The excess solvents include products given off by the reaction, or those added to the reaction. The excess solvents may be removed by separation, vacuum, or other method. Preferably, the excess solvent removal will be accomplished by exposure to vacuum.

Useful fully-epoxidized soybean oils include those commercially available under the trade designations EPDXOL 7-4 (from American Chemical Systems) and FLEXOL ESO (from Dow Chemical Co.).

Also included in the reaction mixture is a ring-opening acid catalyst. In some embodiments, the acid catalyst is fluoroboric acid (HBF₄). The acid catalyst is typically present in an amount ranging from about 0.01% to about 0.3% by weight, more typically ranging from about 0.05% to about 0.15% by weight based upon the total weight of the reaction mixture.

Also included in the reaction mixture is a ring-opener. Various ring-openers may be used including alcohols, water (including residual amounts of water), and other compounds having one or more nucleophilic groups. Combinations of ring-openers may be used. In some embodiments, the ring-opener is a monohydric alcohol. Representative examples include methanol, ethanol, propanol (including n-propanol and isopropanol), and butanol (including n-butanol and isobutanol), and monoalkyl ethers of ethylene glycol (e.g., methyl cellosolve, butyl cellosolve, and the like). In an exemplary embodiment, the alcohol is methanol. In some embodiments, the ring-opener is a polyol. For use in flexible foams, it is generally preferred to use polyols having about 2 or less hydroxyl groups per molecule. Polyol ring-openers useful in making oligomeric polyols for use in flexible foams include, for example, ethylene glycol, propylene glycol, 1,3-propanediol, butylene glycol, 1,4-butane diol, 1,5-pentanediol, 1,6-hexanediol, polyethylene glycol, and polypropylene glycol. Also useful are vegetable oil-based polyols.

The ring-opening reaction is conducted with a ratio of ring-opener to epoxide that is less than stoichiometric in order to promote oligomerization of the epoxidized natural oil. In an exemplary embodiment, epoxidized soybean oil (ESBO) is reacted with methanol in the presence of a ring-opening catalyst, for example, fluoroboric acid. Typically, the molar ratio of methanol to fully epoxidized soybean oil will range from about 0.5 to about 3.0, more typically ranging from about 1.0 to about 2.0. In an exemplary embodiment, the molar ratio of the methanol to the epoxidized soybean oil ranges from about 1.3 to about 1.5.

Typically, at the start of the reaction, the fully epoxidized soybean oil has an epoxide oxygen content (EOC) ranging from about 6.8% to about 7.4%. The ring-opening reaction is preferably stopped before all of the epoxide rings are ring-opened. For some ring-opening catalyst, the activity of the catalyst decreases over time during the ring-opening reaction. Therefore, the ring-opening catalyst may be added to the reactive mixture at a controlled rate such that the reaction stops at (or near) the desired endpoint EOC. The ring-opening reaction may be monitored using known techniques, for example, hydroxyl number titration (ASTM E1899-02) or EOC titration (AOCS Cd9-57 method).

Typically, when fully epoxidized soybean oil is used, the ring-opening reaction is stopped when the residual epoxy oxygen content (EOC) ranges from about 0.01% to about 6.0%, for example, about 0.5% to about 5.5%, about 1% to about 5.0%, about 2% to about 4.8%, about 3% to about 4.6%, or about 4.0% to about 4.5%. When other epoxidized natural oils are used, the residual epoxy oxygen content (EOC) of the polyol may be different. For example, for palm oil, the residual EOC may range from about 0.01% to about 3.5%, for example, about 0.2% to about 3.0%, about 0.5% to about 2.0%, or about 0.8% to about 1.5%. As used herein “epoxy oxygen content” or “EOC” refers to the weight of epoxide oxygen in a molecule expressed as percentage.

During the ring-opening reaction, some of the hydroxyl groups of the ring-opened polyol react with epoxide groups that are present on other molecules in the reactive mixture (e.g., molecules of unreacted fully epoxidized soybean oil or molecules of polyol having unreacted epoxide groups) resulting in oligomerization (i.e., the formation of dimers, trimers, tetramers, and higher order oligomers). The degree of oligomerization contributes to the desired properties of the oligomerized natural oil. In some embodiments, the oligomerized natural oil comprises about 40% weight or greater oligomers (including dimers, trimers, and higher order oligomers). In some embodiments, the oligomeric polyol comprises about 35% to about 45% weight monomeric polyol and about 55% to about 65% weight oligomers (e.g., dimers, trimers, tetramers, and higher order oligomers). For example, in some embodiments, the oligomerized natural oil comprises about 35% to about 45% weight monomeric polyol, about 8% to about 12% weight dimerized polyol, about 5% to about 10% weight trimerized polyol, and about 35% weight or greater of higher order oligomers.

Oligomerization may be controlled, for example, by catalyst concentration, reactant stoichiometry, and degree of agitation during ring-opening. Oligomerization tends to occur to a greater extent, for example, with higher concentrations of catalyst or with lower concentration of ring-opener (e.g., methanol). Upon completion of the ring-opening reaction, any unreacted methanol is typically removed, for example, by vacuum distillation. Unreacted methanol is not desirable because it is a monofunctional species that will end-cap the polyisocyanate. After removing any excess methanol, the resulting polyol is typically filtered, for example, using a 50 micron bag filter in order to remove any solid impurities.

In addition to epoxidation and ring-opening, chemical oligomerization may also be achieved by oligomerizing a natural oil in the presence of a Bronsted or Lewis acid catalyst as described, for example, in U.S. Pat. Nos. 2,160,572 and 2,365,919. Another technique for chemical oligomerization involves cationically catalyzed ring-opening of an epoxidized fatty acid ester. Oligomerization by this method is described, for example, in U.S. Patent Application Publication 2006/0041157A1.

### Amidation and Transesterification

After formation of the oligomeric natural oil, the oligomeric natural oil may be (a) amidated with a polyamine (e.g., diamine) compound to form an amidated oligomeric natural oil polyol; or (b) transesterified with a polyol (e.g., diol) to form a transesterified oligomeric natural oil polyol. In amidation, the amine groups in the polyamine react with the ester linkages that are present in the oligomeric natural oil (i.e., glycerol fatty acid ester bonds) causing the ester groups to cleave resulting in the formation of amide groups and hydroxyl groups. During transesterification, the alcohol groups in the polyol react with the ester linkages that are present in the oligomeric natural oil (i.e., glycerol fatty acid ester bonds) causing the ester groups to cleave resulting in the formation of ester groups and hydroxyl groups. Whether by amidation or transesterification, the formation of hydroxyl groups causes the oligomeric natural oil to become a polyol suitable for use in a viscoelastic foam of the invention. An idealized exemplary reaction sequence for making an amidated polyol using a thermally oligomerized natural oil is shown below in REACTION SCHEMES A and B. An idealized exemplary reaction sequence for making a transesterified polyol using a chemically oligomerized (i.e., epoxidized and ring-opened) natural oil is shown below in REACTION SCHEME C. It is understood that the reaction schemes represent idealized structures that may form during the reactions. As known to one of skill in the art, the actual composition would include other species.

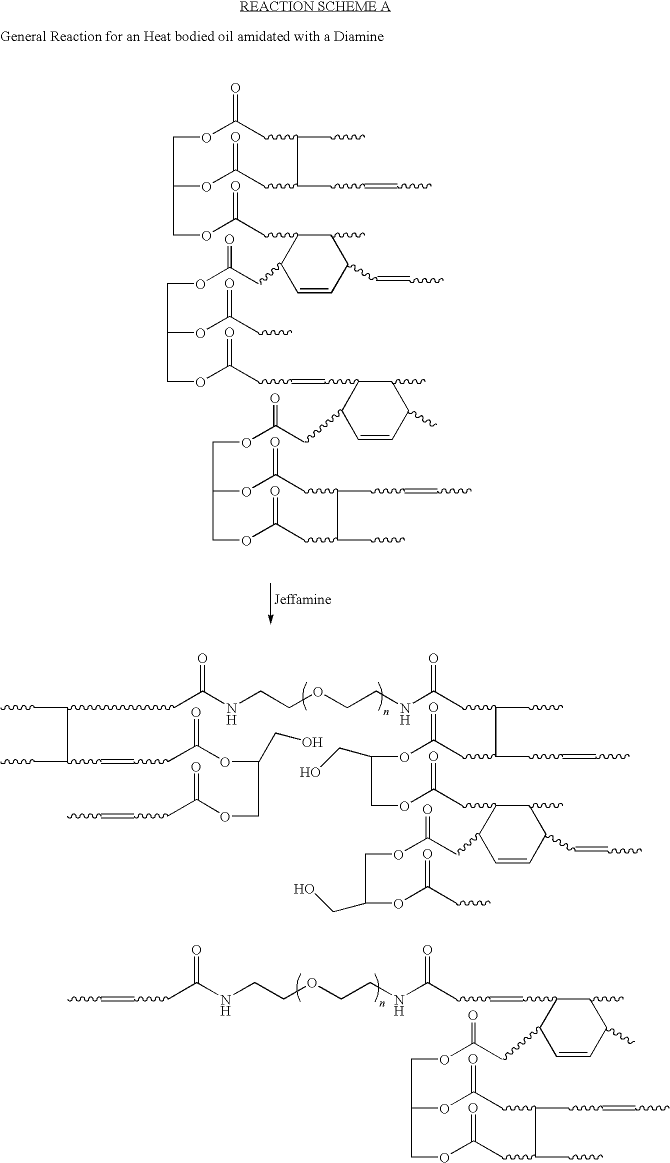

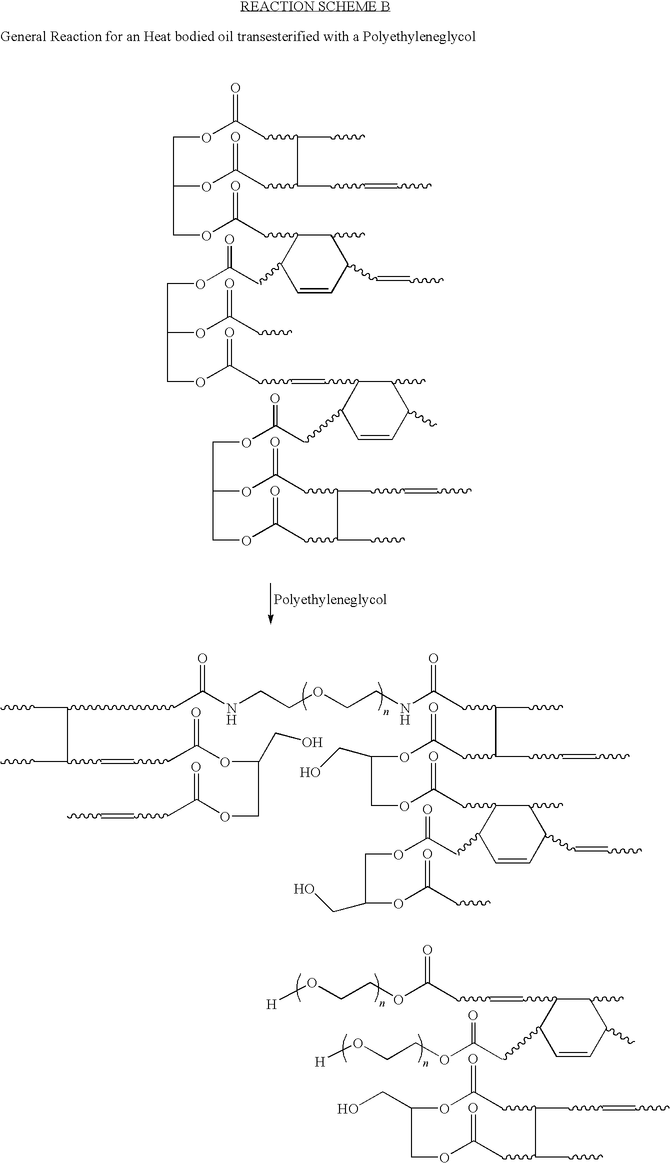

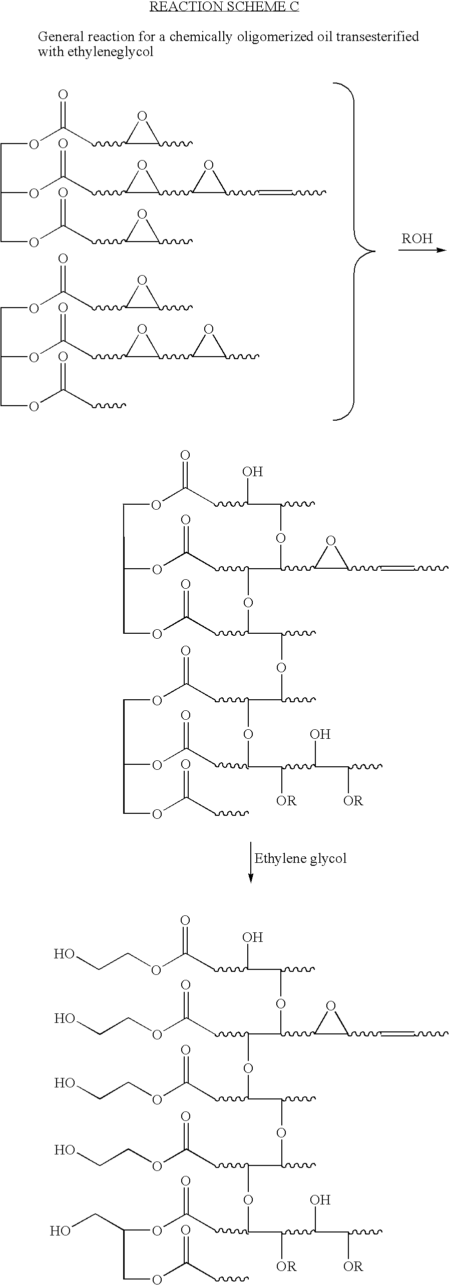

In the amidation or transesterification reaction, the oligomeric natural oil and the polyamine or polyol are reacted at a temperature of about 50° C. to about 250° C. (typically 100°-200° C.) for a time period ranging from about 1 to about 24 hours (typically about 3 to about 10 hours). A catalyst may be used to increase the rate of reaction. Examples of catalysts include tin catalysts, alkali catalysts, acid catalysts, or enzymes. Representative alkali catalysts include NaOH, KOH, sodium and potassium alkoxides (e.g., sodium methoxide), sodium ethoxide, sodium propoxide, sodium butoxide. Representative acid catalysts include sulfuric acid, phosphoric acid, hydrochloric acid, and sulfonic acids.

One useful catalyst is dibutyltin dilaurate (e.g., commercially available under the trade designation “FASCAT 4350”. Typically, the catalyst is added in an amount that ranges from about 0.1% to about 5% weight (typically about 0.1% to about 1% weight) of the reactants. In some embodiments, the catalyst is added in several batches during the amidation reaction.

Useful polyamine compounds for amidation of an oligomeric natural oil include diamine compounds fitting the general formula:

H₂N—R—NH₂

where R is an organic group, for example, an aliphatic group or an aromatic group.

Examples of diamines include polyalkylene glycol diamines, for example, polypropylene glycol diamines, polyethylene glycol diamines; ethylene diamine; 1,3-propanediamine; and 1,4-butanediamine. Also useful are aromatic diamines including aromatic compounds containing amine groups directly attached to an aromatic ring, and aromatic compounds containing hydrocarbon or polyglycols to which are attached amine groups.

In some embodiments, the diamines are amine-terminated polypropylene glycol diamines. In some embodiments, amine-terminated polypropylene glycol diamines can be represented by the formula:

H₂N—[—CH(—CH₃)—CH₂—O—]ₓ—CH₂—CH(—CH₃)—NH₂
where x ranges from about 2 to about 70.

Examples of amine terminated polypropylene glycols include those commercially available under the trade designation “JEFFAMINE D” (from Huntsman Corp.). For example, JEFFAMINE D-230 has a value of x of about 2.5 and a molecular weight of about 230; JEFFAMINE D-400 has a value of x of about 6.1 and a molecular weight of about 430; JEFFAMINE D-2000 has a value of x of about 33 and a molecular weight of about 2000; and JEFFAMINE D-4000 has a value of x of about 68 and a molecular weight of about 4000.

Other useful diamines include polyalkylene glycol diamines. Examples of polyalkylene glycol diames include those commercially available under the trade designation ‘JEFFAMINE ED” (from Huntsman Corp.). These polyalkylene glycol diamines may be represented by the general formula:

H₂N—CH(—CH₃)—CH₂—[—O—CH₂—CH(—CH₃)—]ₓ—[O—CH₂—CH₂—]_{y}—[—O—CH₂—CH(—CH₃)—]_{z}—NH₂
where y is about 2 to about 40;
(x+z) is about 1 to about 6; and
the molecular weight (MW) of the diamine ranges from about 200 to about 2000.
   Examples of JEFFAMINE ED diamines include JEFFAMINE HK-511 (y=2.0; (x+z≅1.2; and MW=220); JEFFAMINE ED-600 (y≅9.0; (x+z)≅3.6; and MW=600); JEFFAMINE ED-900 (y≅12.5; (x+z)≅6.0; and MW=900); and JEFFAMINE ED-2003 (y≅39; (x+z)≅6.0; and MW=2000).

Additionally useful diamine compounds are unhindered diamines such as those commercially available under the trade designation “JEFFAMINE EDR” (from Huntsman Corp.). These unhindered diamines can be represented by the following general formula:

H₂N—(CH₂)ₓ—O—CH₂—CH₂—O—(CH₂)ₓ—NH₂
where x ranges from about 2 to 3; and
the molecular weight (MW) ranges from about 140 to about 180.
   Examples of JEFFAMINE EDR diamines include JEFFAMINE EDR-148 (x=2.0; and MW=148); and JEFFAMINE EDR-176 (x=3.0; and MW=176).

Useful compounds for transesterification include diols such as ethylene glycol, propylene glycol, 1,3-propanediol, 1,4-butanediol, pentanediols, hexanediols, and the like, and mixtures thereof. Also useful are polyethylene, polypropylene and polybutylene glycols of various lengths.

Also useful are alkanolamine compounds. Alkanolamines refer to compounds that include both alcohol functionality and amine functionality. Alkanolamine compounds that contain active-hydrogen containing amine groups (e.g., primary and secondary amines) may participate in both amidation and transesterification reactions. Typically, the amidation reaction proceeds faster than the transesterification reaction when these compounds are used. Examples include monoethanolamine and diethanolamine. Alkanolamines compounds that include tertiary amines (e.g., triethanolamine) participate only in transesterification.

The amount of polyamine or polyol is selected to provide an amidated or transesterified polyol that is suitable for making a viscoelastic polyurethane foam. If the amount of polyamine or polyol incorporated into the amidated or transesterified polyol is too low then the polyurethane polymer may not exhibit the desired viscoelastic properties. Typically, the amount of polyamine or polyol used is effective to amidate or transesterify about 10% or greater of the glycerol fatty acid ester groups that are present in the oligomeric natural oil. In other embodiments, the amount of polyamine or polyol used is effective to amidate or transesterify about 50% or greater of the glycerol fatty acid ester groups that are present in the oligomeric natural oil. Accordingly, in the amidated or transesterified polyol about 90% or less of the glycerol fatty acid ester groups that are initially present in the oligomeric natural oil remain intact after amidation or transesterification. In other embodiments, about 50% or less of the glycerol fatty acid ester groups that are initially present in the oligomeric natural oil remain intact after amidation or transesterification.

In some embodiments, the amount of polyamine or polyol in the amidation or transesterification is effective to provide an amidated or transesterified oligomeric natural oil polyol having a number average hydroxyl functionality (Fn) of about 1.6 or greater when Mn is measured using vapor pressure osmometry (VPO).

One of ordinary skill in the art will appreciate that if the oligomeric natural oil is not fully crosslinked, the amidation or transesterification which cleaves a portion of the glycerol fatty acid ester bonds will also cause some of the fatty acid esters to be cleaved from the resulting amidated or transesterified oligomeric natural oil polyol. This reaction may cause a decrease in the molecular weight of the resulting polyol as compared to the molecular weight of the oligomeric natural oil from which it is formed. Therefore, in some embodiments it may be desirable to use a oligomeric natural oil that has a higher molecular weight than the desired molecular weight of the final amidated or transesterified oligomeric natural oil polyol.

Amidation and transesterification may result in the formation of both primary and secondary hydroxyl groups in the resulting polyol. In some embodiments the amidated or transesterified polyol has at least 10%, at least 15%, at least 20%, at least 25%, and at least 50% hydroxyl functionality in the form of primary hydroxyl groups. In some embodiments, amine functionality may be present in amidated polyol as a result of the presence of partially reacted polyamine compounds. For example, partially-reacted polyamine may result in the presence of primary amine functionality in amidated polyols. The extent of amidation or transesterification may be controlled to provide an amidated or transesterified polyol having the desired functionality and hydroxyl number. In some embodiments, the amidated or transesterified polyol has a number average hydroxyl functionality (Fn) about 10 or less, for example, about 9 or less, about 8 or less, about 7 or less, about 6 or less, about 5 or less, about 4 or less, about 3 or less, about 2 or less. Typically, the number average hydroxyl functionality ranges from about 0.9 to about 3.0. In preferred embodiments, the number average hydroxyl functionality is about 1.6 or greater.

In some embodiments, the amidated or transesterified oligomeric natural oil polyol has a hydroxyl number (OH number) that ranges from about 10 to about 200 mg KOH/g, or from about 20 to about 100 mg KOH/g. Hydroxyl number indicates the number of reactive hydroxyl groups available for reaction. It is expressed as the number of milligrams of potassium hydroxide equivalent to the hydroxyl content of one gram of the sample.

In some embodiments, the amidated or transesterified oligomeric natural oil polyol has a low acid value. Acid value is equal to the number of milligrams of potassium hydroxide (KOH) that is required to neutralize the acid that is present in one gram of a sample of the polyol (i.e., mg KOH/gram). A high acid value is undesirable because the acid may neutralize the amine catalyst causing a slowing of the isocyanate-polyol reaction rate. In some embodiments, the oligomeric polyol has an acid value that is less than about 5 (mg KOH/gram), for example, less than about 4 (mg KOH/gram), less than about 3 (mg KOH/gram), less than about 2 (mg KOH/gram), or less than about 1 (mg KOH/gram). In exemplary embodiments, the acid value is less than about 1 (mg KOH/gram), for example, less than about 0.5 (mg KOH/gram), or from about 0.2 to about 0.5 (mg KOH/gram).

In some embodiments, the number average molecular weight (i.e., Mn) of the amidated or transesterified oligomeric natural oil polyol is about 1000 grams/mole or greater, for example, about 1100 grams/mole or greater, about 1200 grams/mole or greater, about 1300 grams/mole or greater, about 1400 grams/mole or greater, or about 1500 grams/mole or greater. In some embodiments, the Mn is less than about 5000 grams/mole, for example, less than about 4000 grams/mole, less than about 3000 grams/mole, or less than about 2000 grams/mole. In some embodiments, the Mn ranges from about 1000-5000 grams/mole, for example, about 1200-3000 grams/mole, about 1300-2000 grams/mole, about 1700-1900 grams/mole, or about 1500-1800 grams/mole. Number average molecular weight may be measured, for example, using light scattering, vapor pressure osmometry, end-group titration, and colligative properties.

In some embodiments, the weight average molecular weight (i.e., Mw) of the amidated or transesterified oligomeric natural oil polyol is about 2000 grams/mole or greater, for example, about 3000 grams/mole or greater, about 4000 grams/mole or greater, about 5000 grams/mole or greater, about 6000 grams/mole or greater, about 7000 grams/mole or greater, or about 8000 grams/mole or greater. In some embodiments, the Mw is less than about 50,000 grams/mole, for example, less than about 40,000 grams/mole, less than about 30,000 grams/mole, or less than about 20,000 grams/mole. In some embodiments, the Mw ranges from about 2000-50,000 grams/mole, for example, about 5000-20,000 grams/mole, or about 6000-15,000 grams/mole. Weight average molecular weight may be measured, for example, using light scattering, small angle neutron scattering (SANS), X-ray scattering, and sedimentation velocity.

Typically the amidated or transesterified oligomeric natural oil polyol has a polydispersity (Mw/Mn) of about 3-15, for example, about 4-12, or about 5-10.

In some embodiments the amidated or transesterified oligomeric natural oil polyol has a viscosity at 25° C. of less than about 20,000 cP, less than about 15,000 cP, less than about 12,000 cP, less than 10,000 cP, or less than 5,000 cP.

In some embodiments, the amidated or transesterified natural oil polyol has few, if any, residual double bonds. One measure of the amount of double bonds in a substance is its iodine value (IV). The iodine value for a compound is the amount of iodine that reacts with a sample of a substance, expressed in centigrams iodine (I₂) per gram of substance (eg I₂/gram). When chemically oligomerized and amidated or transesterified, the polyol typically has an iodine value of about 50 or less, for example about 40 or less, about 30 or less, about 20 or less, about 10 or less, or about 5 or less. When thermally oligomerized soybean oil is amidated or transesterified, the polyol may have a higher iodine value, for example about 100 or less.

### Active-Hydrogen Containing Composition

Polyurethane compositions of the invention are formed by the reaction of a polyisocyanate with an active-hydrogen containing composition comprising an amidated or transesterified oligomeric natural oil polyol as described previously herein. The amidated or transesterified oligomeric natural oil polyol may make up the entire active-hydrogen containing composition or one or more other polyols (i.e., a secondary polyols) may also be present in the active hydrogen containing composition. For example, in some embodiments, in addition to an amidated or transesterified oligomeric natural oil polyol the active-hydrogen composition may additionally comprise a natural oil-derived polyol, a petroleum-derived polyol, or a mixture thereof. Typically, the secondary polyol comprises from about 0% to about 90% weight, more typically ranging from about 0% to about 20% by weight of the active hydrogen composition. The amount of such secondary polyols can be determined by one of skill in the art based on the type of polyol used and the desired properties of the viscoelastic polyurethane foam.

In some embodiments, the secondary polyol is prepared by a two-step process comprising epoxidation followed by ring-opening of the epoxide groups. Specifically, the two-step process comprises adding a peroxyacid to a natural oil so that the natural oil and peroxyacid react to form an epoxidized natural oil. In the second step, the epoxidized natural oil is added to a mixture of alcohol, water, and a fluoroboric acid catalyst. The epoxidized natural oil undergoes ring-opening of the epoxide groups to form a natural oil-based polyol. Ring-opened polyols are reported, for example, in U.S. Pat. Nos. 6,573,354; 6,686,435; 6,443,121; and 6,107,433. Also useful are oligomeric ring-opened natural oil polyols such as those described in U.S. Patent Publication No. 2006/0041157; and in PCT Publications Nos. WO 2006/012344 (Petrovic et al.) and WO 2006/116456 (Abraham et al.).

Also useful as secondary polyols are petroleum-derived polyols including, for example, polyethers, polyesters, polyacetals, polycarbonates, polyesterethers, polyestercarbonates, polythioethers, polyamides, polyesteramides, polysiloxanes, polybutadienes and polyacetones. In an exemplary embodiment, the petroleum derived polyol is a polyether triol having an average molecular weight of 700 grams/mole, a hydroxyl number of about 238 mgKOH/gram, and functionality of 3. Also useful are ethylene oxide-based polyols (e.g., polyoxyethylene-polyoxypropylene polyols) such as those described in U.S. Pat. No. 6,946,497 (Yu).

As know to those of skill in the art, the choice of polyols or polyol blends will be dependent on the specific properties desired in the viscoelastic foam (hardness, resilience, rate of return, compression set, etc.).

### Polyisocyanates

Viscoelastic polyurethanes of the invention are formed by the reaction of a polyisocyanate with an active-hydrogen composition comprising an amidated or transesterified thermally oligomerized natural oil polyol. Representative examples of useful polyisocyanates include those having an average of at least about 2.0 isocyanate groups per molecule. Both aliphatic and aromatic polyisocyanates can be used. Examples of suitable aliphatic polyisocyanates include 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4-and/or 4,4′-diphenylmethane diisocyanate (H₁₂MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (PMDI), and the like. Derivatives and prepolymers of the foregoing polyisocyanates, such as those containing urethane, carbodiimide, allophanate, isocyanurate, acylated urea, biuret, ester, and similar groups, may be used as well. Included are monomeric diisocyanates (e.g., MONDUR ML); modified isocyanates and polyisocyanates (typically having a % NCO from about 10-45). Modified isocyanates typically have a % NCO of about 10 to about 30 (e.g., MONDUR PF); allophanate modified isocyanates typically have a % NCO of about 16 to about 30 (e.g., MONDUR MA-2300); and polymeric isocyanates typically have a % NCO of about 24 to about 33 (e.g., MONDUR MRS-20). Prepolymers of TDI or MDI (e.g., RUBINATE R-7300 or R-73126 (from Huntsmann)) as well as blends of MDI and TDI are also useful.

Conventionally, in preparing viscoelastic foams, a 65%/35% blend of 2,4-toluene diisocyanate and 2,6-toluene diisocyanate (65/35 TDI) is used because this blend of TDI reacts preferentially with water allowing for the production of lower density foams having reduced shrinkage. Advantageously, viscoelastic foams of the invention may be made using an 80%/20% blend of 2,4-toluene diisocyanate and 2,6-toluene diisocyanate (80/20 TDI). This blend of isomers is substantially less expensive than 65/35 TDI and is easier to work with than 65/35 TDI.

Derivatives and prepolymers of the foregoing polyisocyanates, such as those containing urethane, carbodiimide, allophanate, isocyanurate, acylated urea, biuret, ester, and similar groups, may be used as well.

The amount of polyisocyanate used is typically sufficient to provide an isocyanate index of about 60 to about 100, more typically from about 70 to about 90, and most typically from about 80 to about 85. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active hydrogen atoms.

### Other Ingredients

Other ingredient in the viscoelastic foam include, for example, melamine, acetone, catalysts (e.g., DABCO A1, DABCO 33LV, tin catalysts such as stannous octoate (T9 or K29) and dibutyltindilaurate (T12)); fillers (e.g., CaCO₃); stabilizing or cell opening surfactants; colorants; U.V. stabilizers (e.g., B-75); flame retardants (e.g., FM550 or TB195); bacteriostats, plasticizers, cell openers (e.g., Dow 4053, M-9199, or M-9198), antistatic agents, and blowing agents (e.g., acetone or methylene chloride). Typically, the amount of catalyst will range up to about 0.4% weight, for example, about 0.2% weight to about 0.4% weight.

### Manufacturing of Viscoelastic Foam

Viscoelastic foams of the invention can be manufactured using known techniques for producing viscoelastic foams. For example, in some embodiments, the reactants are mixed together and are poured onto a conveyor where the reacting mixture rises against its own weight and cures to form a slabstock bun having a nominal rectangular cross-section. The resulting bun can be cut into the desired shape to suit the end-use.

Viscoelastic foams of the invention can be manufactured using conventional slabstock foaming equipment, for example, commercial box-foamers, high or low pressure continuous foam machines, crowned block process, rectangular block process (e.g., Draka, Petzetakis, Hennecke, Planiblock, EconoFoam, and Maxfoam processes), or verti-foam process. In some embodiments, the slabstock foam is produced under reduced pressure. For example, in variable pressure foaming (VPF), the complete conveyor section of the foaming machine is provided in an airtight enclosure. This technique allows for the control of foam density and the production of foam grades that may otherwise be difficult to produce. Details of such slabstock foaming processes are reported, for example, in Chapter 5 of Flexible Polyurethane Foams, edited by Herrington and Hock, (2^{nd} Edition, 1997, Dow Chemical Company).

In some instances, it is desirable to post-cure the foam after initial forming (and demolding in the case of molded foam) to develop optimal physical properties. Post-curing may take place under ambient conditions, for example, for a period of about 12 hours to 7 days; or at elevated temperature, for example, for a period of about 10 minutes to several hours.

### Viscoelastic Foam Properties

In many embodiments, the viscoelastic foams of the invention have a density (weight per unit volume) that ranges from about 1.5 to about 6 (lbs/ft³), more typically ranging from about 3 to about 5 (lbs/ft³), and most typically ranging from about 4 to about 5 (lbs/ft³). Foam may be measured, for example, in accordance with ASTM D3574.

Viscoelastic foams of the invention are low resiliency flexible polyurethane foams. Resiliency may be measured, for example, using the ball rebound test. In the ball rebound test, a steel ball of a specified mass is dropped from a fixed height onto a foam sample and the height of the ball rebound from the foam sample is recorded. The ball rebound value is equal to the rebound height attained by the steel ball expressed as a percentage of the original drop height. Ball rebound may be measured, for example, according to ASTM D3574. In many embodiments, the viscoelastic foams of the invention have a ball rebound of about 20% or less, about 15% or less, about 10% or less, about 5% or less, or about 1% or less.

Many properties of viscoelastic foams can be measured using dynamic mechanical analysis (DMA). Dynamic mechanical analysis is a technique used to study and characterize materials, including viscoelastic polymers. In DMA an oscillating force is applied to a sample and the resulting displacement of the material is measured. From this the stiffness of the sample can be measured and the modulus of the sample can be calculated. By measuring the time lag in the displacement it is also possible to determine the damping properties of the material.

In many embodiments, the viscoelastic foams of the invention display a low storage modulus (G′) and a low loss modulus (G″) at low temperatures (e.g., −30° C.). Storage and loss modulus can be measured, for example, using DMA. A low storage modulus is characteristic of viscoelastic foam that remains soft at low temperatures. Similarly, a low loss modulus is characteristic of viscoelastic foam that remains soft at low temperatures. In some embodiments, viscoelastic polyurethane foams of the invention display a storage modulus (G′) that is about 45.23 MPa or less at −30° C. In some embodiments, viscoelastic polyurethane foams of the invention display a maximum loss modulus (G″) that is about 5.07 MPa or less at −19.9° C. By contrast, many commercially available viscoelastic foams display a storage modulus (G′) of about 103.3 MPa at −30° C. and a maximum loss modulus (G″) of about 10.27 MPa at 3.4° C. In many embodiment, the storage modulus ratio between −30° C. and 50° C. for viscoelastic foams of the invention is less than the storage modulus ratio between −30° C. and 50° C. that is obtained for a comparable viscoelastic foam prepared with a petroleum-derived polyol. Because of this, embodiments of the viscoelastic foams of the invention display improved damping properties and improved cold temperature properties, which allows them to be used in cold temperature conditions where conventional viscoelastic foams comprising petroleum-derived polyols may not display acceptable properties.

The glass transition temperature of viscoelastic polyurethane foams can be determined using dynamic mechanical analysis (DMA). Viscoelastic foams of the invention typically have glass transition temperature that is near room temperature (e.g., 20° C.), for example, typically ranging from about −40° C. to about 40° C. Embodiments of the viscoelastic foams of the invention typically display a broad, low intensity Tg peak when measured by DMA. This is in comparison with viscoelastic foams that are prepared using petroleum-derived polyols, which typically display a sharper, higher intensity peak. While not being bound by theory, it is believed that the broad, low intensity peak is the result of the broad molecular weight and hydroxyl number distribution in the amidated or transesterified oligomeric natural oil polyols described herein, along with the non-uniform molecular structure of these polyols.

Another useful foam property includes a lower rate of return after deformation (i.e., lower hysteresis). Hysteresis loss is a measurement of the energy lost or absorbed by a foam when subjected to deflection. It is typically calculated by the following equation:

% Hysteresis=(Return 25% IFD Value/Original 25% IFD Value)*100%.

Original 25% IFD may be measured in accordance with ASTM 3574(B1). Return 25% IFD may be measured in accordance with ASTM 3574 (B1), except that after measuring the 65% IFD in accordance with the test (See, Section 20.3), the deflection is decreased to 25% and the force is allowed to drift while maintaining the 25% deflection. The force is then measured after 60±3 seconds, and is reported as Return 25% IFD. Hysteresis measures the ability of a foam to dampen vibrations and is equal to the area under the stress-strain curve as a load is applied and released.

In some embodiments of the invention, the viscoelastic foams display an ultimate recovery of about 95% or greater, more typically about 98% or greater, and most typically about 100% or greater.

Indentation force deflection (IFD) is a measure of the load bearing quality of a foam. IFD is typically expressed in Newtons per 323 square centimeters (N/323 cm²) at a given percentage deflection of the foam. The higher the force, the firmer the foam. To obtain IFD, a 323 square centimeter circular plate is pushed into the top surface of a foam sample, stopping at a given deflection, and reading a force on the scale. For example, a 25% IFD of 150 means that a force of 150 N/323 cm² is required to compress a 100 mm thick sheet of foam to a thickness of 75 mm. IFD may be measured, for example, using ASTM D3574. In embodiments of the invention, the 25% IFD ranges from about 30 to about 60 N/323 cm².

Air flow may also be used to characterize the nature of the cellular structure of the viscoelastic foams of the invention. Air flow may be measured, for example, as described in ASTM D3574 (Test G). The test consists of placing a flexible foam core specimen in a cavity over a chamber and creating a specified constant air-pressure differential. The rate of flow of air required to maintain the differential is the air flow value. Foams displaying an open cellular structure typically exhibit higher air flow values than those having a closed cellular structure. In many embodiments, the viscoelastic foams of the invention have an air flow value that ranges from about 0.5 to about 5.0 ft³/minute (SCFM), more typically ranging from about 0.5 to about 2.0 ft³/minute (SCFM).

In many embodiments, the viscoelastic polyurethane foams of the invention display a desirable low odor. In some embodiments, low odor is achieved by formulating the foams without the use of an A1-type catalyst. As used herein the term “A1-type catalyst” refers to a polyurethane catalysts that comprise (dimethylaminoethyl)ether and dipropylene glycol. Examples of A1-type catalysts include “NIAX A1” which comprises about 70% (dimethylaminoethyl)ether and about 30% dipropylene glycol. Conventionally, A1-type catalysts are used to promote viscoelastic properties in polyurethanes. Polyurethane compositions of the invention are able to achieve viscoelastic properties without the need for an A1-type catalyst, thus allowing this component to be removed from the formulation. For example, in many embodiments, the viscoelastic polyurethane foams comprise about 0.1% weight or less A1-type catalyst, about 0.01% weight or less A1-type catalyst, or about 0.001% weight or less A1-type catalyst.

In many embodiments, low odor viscoelastic polyurethane foam is achieved with the use of a low odor amidified or transesterified oligomeric natural oil polyol. Polyol odor can be measured, for example, using human test panels or by measuring the amount of certain odor-producing compounds that may be present in the polyol, for example, using gas chromatography (GC) headspace analysis. Examples of odor-producing compounds include lipid oxidation products, which are typically aldehyde compounds, for example, hexanal, nonanal, and decanal. In many embodiments, the amidified or transesterified oligomeric natural oil polyol has a total odor level of about 400 ppm or less of odor-producing compounds such as hexanal, nonanal, and decanal when measured by GC headspace analysis. In more preferred embodiments, the amidified or transesterified oligomeric natural oil polyol has a total odor level of about 75 ppm or less or about 20 ppm or less of odor-producing compounds such as hexanal, nonanal, and decanal when measured by GC headspace analysis.

The invention will now be described with reference to the following non-limiting examples.

### Examples

Ingredient List

| Abbreviation | Description | Manufacturer |
|---|---|---|
| 1XS-500 | Ring-opened and oligomerized | Cargill |
| | soybean oil-based polyol having a | |
| | hydroxy number of 53-59 mg | |
| | KOH/gram; an acid number of | |
| | 0.27-0.28 mg KOH/g; and a | |
| | viscosity of 4000-9000 cP | |
| 1XS-306 | amidated thermally oligomerized | Cargill |
| | soybean oil polyol; | |
| 1XS-304 | amidated thermally oligomerized | Cargill |
| | soybean oil polyol; | |
| 1XS-308 | Transesterified thermally | Cargill |
| | oligomerized soybean oil polyol | |
| X-210 | Natural oil-based polyol | Cargill |
| ESBO | Epoxidized Soybean Oil | Cargill |
| HS-100 | Petroleum-derived polyol | Bayer |
| E-849 | Petroleum-derived FR polyol | Bayer |
| LHT-240 | Petroleum-derived polyether triol | Bayer |
| PTMEG | Petroleum-derived polyether | Lyondell |
| 2000 | polyol | |
| L-620 | Silicone | GE Silicone |
| L-6164 | Rigid Silicone | GE Silicone |
| CS-23 | Amine | OSI |
| F-3022 | polyether polyol; 3,000-molecular | Bayer |
| | weight triol; functionality 3; | |
| | hydroxyl number 56 mg KOH/g; | |
| | molecular weight 3,000; | |
| | viscosity 480 cP @ 25° C. | |
| B-4690 | HR Silicone | Degussa |
| T-9 | Tin Catalyst | Air Products |
| 33LV | Amine Catalyst | Air Products |
| TDI | TDI 80/20 | Bayer |
| MRS-20 | PDMI | Bayer |

Synthesis of 1XS-306 Amidated Thermally Oligomerized Natural Oil Polyol

Bodied soybean oil (6000 g, 10 OH#, from Cargill), Jeffamine D400 (1875 g, MW=428, 2 amino groups/molecule, from Huntsman) and Fascat 4350 catalyst (7.9 g) were placed in a large reactor, equipped with a thermocouple and condenser, heated at 170 C, and the amine number monitored to determine extent of amidation. After about 6 hours, additional Fascat 4350 catalyst (2.6 g) was added and the reaction continued. The reaction was stopped after a total of 12 hours when the amine number had dropped to below 1. Two runs according to the above procedure were conducted and the resulting polyols were blended to produce a polyol having the following characteristics.

1XS-306 Polyol

| Property | Value |
|---|---|
| OH Number | 78.4 mg KOH/g |
| | polyol |
| Acid Value | 2.0 |
| Viscosity | 8307 cP at 25° C. |
| Water | 507 ppm |
| Color (Gardner) | 10 |
| Peroxide Value | 0 |
| Mn (GPC) | 1591 |
| Mw (GPC) | 3481 |
| Functionality (GPC) | 2.22 |

Synthesis of 1XS-304 Amidated Thermally Oligomerized Natural Oil Polyol

Heat Bodied soybean oil (7508 g, 10 OH#, from Cargill), Jeffamine D400 (1170 g, MW=428, 2 amino groups/molecule, from Huntsman) and Fascat 4350 catalyst (8.70 g) were placed in a large glass reactor equipped with a stirrer, thermocouple, heating mantle, condenser, and a nitrogen sweep. The reaction mixture was heated to 170 C with stirring and the amine number monitored to determine extent of amidation. After about 5 hours, the amine number had been reduced from an initial value of 25.6 mg KOH/g to 0.8 mg KOH/g. The reaction was continued for another 1 hour with no further reduction in the amine number. The final product was clear and required no filtration. The properties of the resulting polyol are provided below.

1XS-304 Polyol

| Property | Value |
|---|---|
| OH Number | 44.9 mg KOH/g |
| | polyol |
| Acid Value | 4.4 |
| Viscosity | 6982 cP at 25° C. |
| Water | 664 ppm |
| Color (Gardner) | 9 |
| Peroxide Value | 0 |
| Mn (GPC) | 1755 |
| Mw (GPC) | 5265 |
| Functionality (GPC) | 1.402 |
| Mn (VPO) | 1889 |
| Functionality (VPO) | 1.51 |

Synthesis of 1XS-308 Transesterified Thermally Oligomerized Soybean Oil Polyol

1XS-308 polyol was synthesized as described in EXAMPLE 9 herein. The properties of the resulting polyol are listed below.

1XS-308 Polyol

| Property | Value |
|---|---|
| OH Number | 75 mg KOH/g |
| | polyol |
| Functionality (Fn) | 1.51 |
| (GPC) | |
| Viscosity | 1250 mPa · s at 25° C. |
| Molecular Weight | 2690 |
| (Mn) (GPC) | |
| Percent SAN Solids | 0 |
| EO Capped | NO |

General Foam Procedure

1. An empty tri-pour beaker of the proper size for the amount of the desired foam formulation to be mixed was tared on a balance.

2. The required amounts of polyol, surfactant, catalysts, blowing agents and other ingredients were added to the beaker.

3. A tri-pour beaker of the proper size with the desired isocyanate was wet tared.

4. Referring to the formulation sheet, the amount of isocyanate for the desired foam index was added to the beaker.

5. The tri-pour beaker holding the polyol was placed on a mixer and was mixed for 30 seconds with the stirrer blade completely immersed to the bottom of the beaker.

6. With 6 seconds remaining in the mix time, the pre-weighed isocyanate was added to the polyol. A stopwatch was started when the isocyanate was added.

7. When the mixer stopped, the contents of the beaker were poured into a suitable size paper or plastic bucket. The foam was then allowed to rise and cure in the bucket.

8. Physical properties of the resulting polyurethane foams were tested and are reported below.

### Example 1

Polyurethane foams having the formulations listed in TABLE 1-1 were prepared using the General Foam Procedure provided above. The physical properties of the foams are provided in TABLE 1-2.

TABLE 1-1

| | | Sample I.D. | | | | | |
|---|---|---|---|---|---|---|---|
| | OH# | 87 | 101 | 102 | 103 | 104 | 105 |
| 1XS-306 | 63.5 | 100 | 80 | 80 | 80 | 90 | 100 |
| F-3022 | 56.0 | | 20 | | | | |
| 1XS-500 | 56.0 | | | 20 | 20 | | |
| X-210 | 225.0 | | | | | 10.00 | |
| Water | 6228.0 | 1.00 | 1.00 | 1.00 | 1.00 | 1.00 | 1.00 |
| B-4690 | 0.0 | 1.50 | 1.50 | 1.50 | 1.50 | 1.50 | 1.50 |
| T-9 | 0.0 | 1.00 | 1.00 | 1.00 | 1.00 | 1.00 | 1.00 |
| Total parts | | 103.50 | 103.50 | 103.50 | 103.50 | 103.50 | 103.50 |
| ISO index | | 100% | 100% | 100% | 90% | 90% | 90% |
| ISO calculation | | 19.51 | 19.27 | 19.27 | 17.35 | 19.81 | 17.55 |
| % NCO | | 48.30 | 48.30 | 48.30 | 48.30 | 48.30 | 48.30 |
| ISO Type | | TDI | TDI | TDI | TDI | TDI | TDI |
| CT | | ok | ok | ok | ok | ok | ok |
| Blow off | | no | no | no | no | no | no |
| Settle | | no | no | no | no | no | no |
| Boiling | | no | no | no | no | no | no |
| Cell | | fine | fine | fine | fine | fine | fine |
| Shrinkage | | some | some | some | some | some | some |

TABLE 1-2

| | | Sample I.D. | | | | | | ASTM | |
|---|---|---|---|---|---|---|---|---|---|
| | | 87 | 101 | 102 | 103 | 104 | 105 | D3574 | Minimun |
| Density | lbs/ft³ | 4.20 | 4.47 | 4.30 | 4.74 | 4.42 | 4.79 | A | |
| Resilience | % | 7.00 | 11.00 | 8.00 | 1.33 | 6.00 | 1.00 | H | |
| IFD 25%* | lbf | 1.86 | 2.37 | 1.88 | 2.21 | 1.57 | 2.51 | B1 (4 × 4 × 3) | 11-15 |
| Modulus* | | 5.08 | 3.32 | 3.53 | 6.37 | 4.95 | 9.72 | B1 (4 × 4 × 3) | |
| Hysteresis | % | 47.22 | 10.72 | 19.14 | 54.48 | 59.89 | 96.87 | B1 (4 × 4 × 3) | |
| Loss* | | | | | | | | | |
| CFD | psi | 0.16 | 0.24 | 0.22 | 0.16 | 0.18 | no recover | C | |
| | | | | | | | | (cored) | |
| Tensile | psi | 4.84 | 4.82 | 3.35 | 2.35 | 4.58 | 2.98 | E | 5.00 |
| Ultimate | % | 109.79 | 117.49 | 85.69 | 94.64 | 119.50 | 144.80 | E | 100.00 |
| Elongation | | | | | | | | (auto grips) | |
| Tear Resistance | pli | 0.63 | 0.74 | 0.47 | 0.34 | 0.64 | NA | F | 0.50 |
| Air Flow** | SCFM | 4.47 | 3.81 | 3.72 | 4.17 | 3.36 | NA | G | |
| Comp Set @ | % | 89.67 | 80.13 | 89.97 | 87.32 | 82.80 | NA | D | |
| 90% Reg, Ct. | | | | | | | | (Ct.) | |

*The block sample size used was 4 × 4 × 3 inches rather than 4 × 4 × 15 inches. The following factor to estimated 25% IFD from 4 × 4 × 3 block to 4 × 4 × 15 inch block. For formulations having 1 part of water, the factor was 3.92. For formulations having 1.5 parts of water, the factor was 4.77. For formulations having 2.5 parts of water, the factor was 5.32.
**The block sample size used was 2 × 2 × 1 inches.

### Example 2

Polyurethane foams having the formulations listed in TABLE 2-1 were prepared using the General Foam Procedure. The physical properties of the foams are provided in TABLE 2-2.

TABLE 2-1

| | | Sample I.D. | | | | | | | |
|---|---|---|---|---|---|---|---|---|---|
| | OH# | 82 | 83 | 85 | 86 | 88 | 89 | 90 | 92 |
| 1XS-306 (Lot | 63.5 | 90 | 80 | 100 | 100 | 80.00 | 80.00 | 80.00 | |
| 6544.97) | | | | | | | | | |
| F-3022 | 56.0 | | 20 | | | | | 20.00 | |
| X-500 | 56.0 | | | | | 20.00 | | | |
| X-304 | 44.9 | | | | | | 20.00 | | 100.00 |
| Water | 6228.0 | 1.50 | 1.50 | 1.50 | 1.50 | 1.50 | 1.50 | 1.50 | 1.50 |
| B-4690 | 0.0 | 1.50 | 1.50 | 1.50 | 1.50 | 1.50 | 1.50 | 1.50 | |
| 33LV | 560.0 | 0.20 | 0.20 | 0.20 | | | | | |
| T-9 | 0.0 | 1.00 | 1.00 | 1.00 | 1.00 | 1.00 | 1.00 | 1.00 | 1.25 |
| L-620 | 0.0 | | | | | | | | 0.50 |
| ESO | 6.5 | 10.00 | | | | | | | |
| Total parts | | 104.20 | 104.20 | 104.20 | 104.00 | 104.00 | 104.00 | 104.00 | 103.25 |
| ISO index | | 100% | 100% | 100% | 100% | 100% | 100% | 100% | 100% |
| ISO calculation | | 23.62 | 24.28 | 24.51 | 24.33 | 24.10 | 23.76 | 24.10 | 21.45 |
| % NCO | | 48.30 | 48.30 | 48.30 | 48.30 | 48.30 | 48.30 | 48.30 | 48.30 |
| ISO Type | | TDI | TDI | TDI | TDI | TDI | TDI | TDI | TDI |
| CT | | ok | ok | ok | ok | ok | ok | ok | ok |
| Blow off | | no | no | no | no | no | no | no | no |
| Settle | | no | no | no | no | no | no | no | yes-2 |
| | | | | | | | | | inches |
| Boiling | | no | no | no | no | no | no | no | no |
| Cell | | fine | fine | fine | fine | fine | fine | fine | fine |
| Shrinkage | | some | some | some | some | some | some | some | some |

TABLE 2-2

| | | Sample I.D. | | | | | | | | ASTM | |
|---|---|---|---|---|---|---|---|---|---|---|---|
| | | 82 | 83 | 85 | 86 | 88 | 89 | 90 | 92 | D3574 | Minimun |
| Density | lbs/ft³ | 2.97 | 2.90 | 2.99 | 3.01 | 2.96 | 3.16 | 3.05 | 4.39 | A | |
| Resilience | % | 13.00 | 14.30 | 13.00 | 12.70 | 14.00 | 14.70 | 16.70 | 25.00 | H | |
| IFD 25%* | lbf | 1.96 | 1.96 | 1.84 | 1.75 | 2.12 | 2.02 | 2.17 | 5.21 | B1 | 11-15 |
| | | | | | | | | | | (4 × 4 × 3) | |
| Modulus* | | 3.24 | 2.88 | 3.00 | 3.14 | 2.96 | 2.85 | 3.53 | 2.73 | B1 | |
| | | | | | | | | | | (4 × 4 × 3) | |
| Hysteresis Loss* | % | 21.42 | 11.21 | 25.40 | 22.18 | 23.23 | 23.41 | 13.46 | 22.84 | B1 | |
| | | | | | | | | | | (4 × 4 × 3) | |
| 50% CFD | psi | 0.18 | 0.17 | 0.22 | 0.22 | 0.22 | 0.23 | 0.22 | 0.60 | C | |
| | | | | | | | | | | (Cored) | |
| Tensile | psi | 4.72 | 6.88 | 5.51 | 5.62 | 4.96 | 5.19 | 7.23 | 6.14 | E | 5.00 |
| Ultimate | % | 88.56 | 132.77 | 92.15 | 100.14 | 78.07 | 84.14 | 129.46 | 52.38 | E | 100.00 |
| Elongation | | | | | | | | | | (auto | |
| | | | | | | | | | | grips) | |
| Tear Resistance | pli | 0.59 | 0.86 | 0.76 | 0.66 | 0.56 | 0.63 | 0.91 | 0.53 | F | 0.50 |
| Air Flow** | SCFM | 5.00 | 5.00 | 5.00 | 5.00 | 4.89 | 5.00 | 5.00 | 0.94 | G | |
| Comp Set @ | % | 86.16 | 84.04 | 86.94 | 85.71 | 85.74 | 84.02 | 83.14 | 71.13 | D | |
| 90% Reg, Ct. | | | | | | | | | | (Ct.) | |

*The block sample size used was 4 × 4 × 3 inches rather than 4 × 4 × 15 inches. The following factor to estimated 25% IFD from 4 × 4 × 3 block to 4 × 4 × 15 inch block. For formulations having 1 part of water, the factor was 3.92. For formulations having 1.5 parts of water, the factor was 4.77. For formulations having 2.5 parts of water, the factor was 5.32.
**The block sample size used was 2 × 2 × 1 inches.

### Example 3

Polyurethane foams having the formulations listed in TABLE 3-1 were prepared using the General Foam Procedure. The physical properties of the foams are provided in TABLE 3-2.

TABLE 3-1

| | | Sample I.D. | | | | | | |
|---|---|---|---|---|---|---|---|---|
| | OH# | 97 | 98 | 99 | 108 | 109 | 106 | 107 |
| 1XS-306 (Lot | 63.5 | 100 | 80 | 80 | 100 | 100 | 100 | 100 |
| 6544.97) | | | | | | | | |
| F-3022 | 56.0 | | 20 | | | | | |
| X-500 | 56.0 | | | 20 | | | | |
| Water | 6228.0 | 1.50 | 1.50 | 1.50 | 1.50 | 1.50 | 2.50 | 2.50 |
| B-4690 | 0.0 | 1.50 | 1.50 | 1.50 | 1.50 | 1.75 | 1.50 | 1.50 |
| 33LV | 560.0 | | | | | | | |
| T-9 | 0.0 | 1.00 | 1.00 | 1.00 | 0.50 | 0.45 | 1.00 | 0.80 |
| Total parts | | 104.00 | 104.00 | 104.00 | 103.50 | 103.70 | 105.00 | 104.80 |
| ISO index | | 90% | 90% | 90% | 90% | 90% | 90% | 90% |
| ISO calculation | | 21.90 | 32.24 | 21.69 | 32.55 | 32.55 | 30.59 | 30.59 |
| % NCO | | 48.30 | 32.50 | 48.30 | 32.50 | 32.50 | 48.30 | 48.30 |
| ISO Type | | TDI | MRS-20 | TDI | MRS-20 | MRS-20 | TDI | TDI |
| CT | | ok | ok | ok | ok | ok | ok | ok |
| Blow off | | no | no | no | no | no | no | no |
| Settle | | no | no | no | no | no | no | no |
| Boiling | | no | no | no | no | no | no | no |
| Cell | | fine | fine | fine | fine | fine | fine | fine |
| Shrinkage | | some | some | some | some | some | some | some |

TABLE 3-2

| | | Sample I.D. | | | | | | | ASTM | |
|---|---|---|---|---|---|---|---|---|---|---|
| | | 97 | 98 | 99 | 108 | 109 | 106 | 107 | D3574 | Minimun |
| Density | lbs/ft³ | 3.18 | 3.25 | 3.18 | 3.86 | 4.05 | 1.99 | 2.15 | A | |
| Resilience | % | 8.00 | 12.00 | 11.00 | 7.00 | 7.33 | 17.67 | 17.67 | H | |
| IFD 25%* | lbf | 1.97 | 2.28 | 1.86 | 1.96 | 2.28 | 1.63 | 1.74 | B1 | 11-15 |
| | | | | | | | | | (4 × 4 × 3) | |
| Modulus* | | 6.07 | 5.08 | 4.29 | 3.25 | 3.20 | 2.69 | 2.86 | B1 | |
| | | | | | | | | | (4 × 4 × 3) | |
| Hysteresis Loss* | % | 56.74 | 21.74 | 23.76 | 25.43 | 29.94 | 27.79 | 29.84 | B1 | |
| | | | | | | | | | (4 × 4 × 3) | |
| CFD | psi | 0.12 | 0.15 | 0.14 | 0.23 | 0.26 | 0.20 | 0.21 | C | |
| | | | | | | | | | (cored) | |
| Tensile | psi | 4.39 | 5.60 | 4.14 | 8.39 | 6.64 | 4.89 | 4.46 | E | 5.00 |
| Ultimate | % | 107.98 | 144.29 | 93.17 | 103.69 | 81.16 | 77.96 | 74.80 | E | 100.00 |
| Elongation | | | | | | | | | (auto | |
| | | | | | | | | | grips) | |
| Tear Resistance | pli | 0.53 | 0.53 | 0.46 | 0.61 | 0.57 | 0.49 | 0.49 | F | 0.50 |
| Air Flow** | SCFM | 4.67 | 5.00 | 4.42 | 3.28 | 3.44 | 5.00 | 5.00 | G | |
| Comp Set @ | % | 87.99 | 88.75 | 89.04 | 85.84 | 83.81 | 85.53 | 86.65 | D | |
| 90% Reg (Ct.) | | | | | | | | | (Ct.) | |

*The block sample size used was 4 × 4 × 3 inches rather than 4 × 4 × 15 inches. The following factor to estimated 25% IFD from 4 × 4 × 3 block to 4 × 4 × 15 inch block. For formulations having 1 part of water, the factor was 3.92. For formulations having 1.5 parts of water, the factor was 4.77. For formulations having 2.5 parts of water, the factor was 5.32.
**The block sample size was 2 × 2 × 1.

### Example 4

Polyurethane foams having the formulations listed in TABLE 4-1 were prepared using the General Foam Procedure. The physical properties of the foams are provided in TABLE 4-2.

TABLE 4-1

| | | Sample I.D. | | | |
|---|---|---|---|---|---|
| | OH# | 47 | 48 | 59 | 61 |
| HS-100 | 28.3 | 25 | 25 | | |
| E-849 | 18.1 | | | 25 | 25 |
| LHT-240 | 238.0 | 25 | 25 | 25 | 25 |
| X-500 | 56.0 | 50 | 50 | 50 | 50 |
| PTMEG 2000 | | | 6 | | |
| Water | 6228.0 | 2.30 | 2.30 | 1.50 | 1.00 |
| L-620 | 0.0 | 0.60 | 0.60 | 0.20 | 0.50 |
| L-6164 | 0.0 | 0.70 | 0.70 | 0.70 | 0.70 |
| CS-23 | 560.0 | 0.40 | 0.40 | 0.40 | 0.40 |
| T-9 | 0.0 | 0.30 | 0.30 | 0.30 | 0.30 |
| Total parts | | 104.30 | 110.30 | 103.10 | 102.90 |
| ISO index | | 90% | 90% | 90% | 90% |
| ISO calculation | | 33.50 | 33.50 | 26.19 | 21.85 |
| % NCO | | 48.30 | 48.30 | 48.30 | 48.30 |
| ISO Type | | TDI | TDI | TDI | TDI |
| CT | | 19 | 19 | 20 | 29 |
| Blow off | | yes | yes | yes | yes |
| Settle | | no | no | no | no |
| Boiling | | no | no | no | no |
| Cell | | fine | fine | fine | fine |
| Shrinkage | | no | no | no | no |

TABLE 4-2

| | | Sample I.D. | | | | ASTM | |
|---|---|---|---|---|---|---|---|
| | | 47 | 48 | 59 | 61 | D3574 | Minimun |
| Density | lbs/ft³ | 2.33 | 2.53 | 3.40 | 4.87 | A | |
| Resilience | % | 10.33 | 12.00 | 13.67 | 16.00 | H | |
| IFD 25%* | lbf | 24.73 | 26.08 | 21.40 | 26.41 | B1 (4 × 4 × 3) | 11-15 |
| Modulus* | | 1.90 | 2.00 | 1.90 | 2.18 | B1 (4 × 4 × 3) | |
| CFD | psi | NA | NA | NA | NA | C | |
| | | | | | | (cored) | |
| Tensile | psi | 12.68 | 8.99 | 10.94 | 8.85 | E | 5.00 |
| Ultimate Elongation | % | 78.80 | 60.10 | 92.00 | 87.80 | E | 100.00 |
| | | | | | | (auto grips) | |
| Tear Resistance | pli | 1.14 | 1.26 | 0.80 | 0.70 | F | 0.50 |
| Air Flow** | SCFM | 0.83 | 0.83 | 0.83 | 0.83 | G | |
| Comp Set @ 90% Reg (Ct.) | % | 15.40 | 8.40 | 4.70 | 2.35 | D | |
| | | | | | | (Ct.) | |

*The block sample size used was 4 × 4 × 3 inches rather than 4 × 4 × 15 inches. The following factor to estimated 25% IFD from 4 × 4 × 3 block to 4 × 4 × 15 inch block. For formulations having 1 part of water, the factor was 3.92. For formulations having 1.5 parts of water, the factor was 4.77. For formulations having 2.5 parts of water, the factor was 5.32.
**The block sample size used was 2 × 2 × 1 inches.

### Example 5

Physical properties were tested on commercially-available viscoelastic polyurethane foam samples 10-1, 10-2, and 10-3. The results of the physical property testing is reported in TABLE 5-1.

TABLE 5-1

| | | Sample I.D. | | | ASTM | |
|---|---|---|---|---|---|---|
| | | 10-1 | 10-2 | 10-3 | D3574 | Minimun |
| Density | lbs/ft³ | 2.56 | 3.56 | 4.99 | A | |
| Resilience | % | 11.00 | 7.00 | 1.00 | H | |
| IFD 25%* | lbf | 2.82 | 2.60 | 2.88 | B1 (4 × 4 × 3) | 11-15 |
| Modulus* | | 2.38 | 2.83 | 2.60 | B1 (4 × 4 × 3) | |
| Hysteresis Loss* | % | 14.83 | 14.46 | 4.52 | B1 (4 × 4 × 3) | |
| CFD | psi | 0.28 | 0.28 | 0.26 | C | |
| | | | | | (cored) | |
| Tensile | psi | 22.10 | 11.60 | 8.70 | E | 5.00 |
| Ultimate Elongation | % | 213.48 | 165.46 | 265.33 | E | 100.00 |
| | | | | | (auto grips) | |
| Tear Resistance | pli | 2.06 | 0.97 | 1.49 | F | 0.50 |
| Air Flow** | SCFM | 0.83 | 1.67 | 0.83 | G | |
| Comp Set @ 90% Reg (Ct.) | % | 74.42 | 76.53 | 5.90 | D | |
| | | | | | (Ct.) | |
| IFD 25% | lbf | 15.00 | 12.40 | 11.28 | B1 | |
| | | | | | (15 × 15 × 4) | |
| IFD 65% | lbf | 38.99 | 36.60 | 25.98 | B1 | |
| | | | | | (15 × 15 × 4) | |
| 25% Recovery | lbf | 12.53 | 10.44 | 10.54 | B1 | |
| | | | | | (15 × 15 × 4) | |
| Modulus | | 2.53 | 2.95 | 2.30 | B1 | |
| | | | | | (15 × 15 × 4) | |
| Hysteresis Loss | % | 16.57 | 15.86 | 6.58 | | |

*The block sample size used was 4 × 4 × 3 inches rather than 4 × 4 × 15 inches. The following factor to estimated 25% IFD from 4 × 4 × 3 block to 4 × 4 × 15 inch block. For formulations having 1 part of water, the factor was 3.92. For formulations having 1.5 parts of water, the factor was 4.77. For formulations having 2.5 parts of water, the factor was 5.32.
**The block sample size used was 2 × 2 × 1 inches.

### Example 6

### DMA Testing

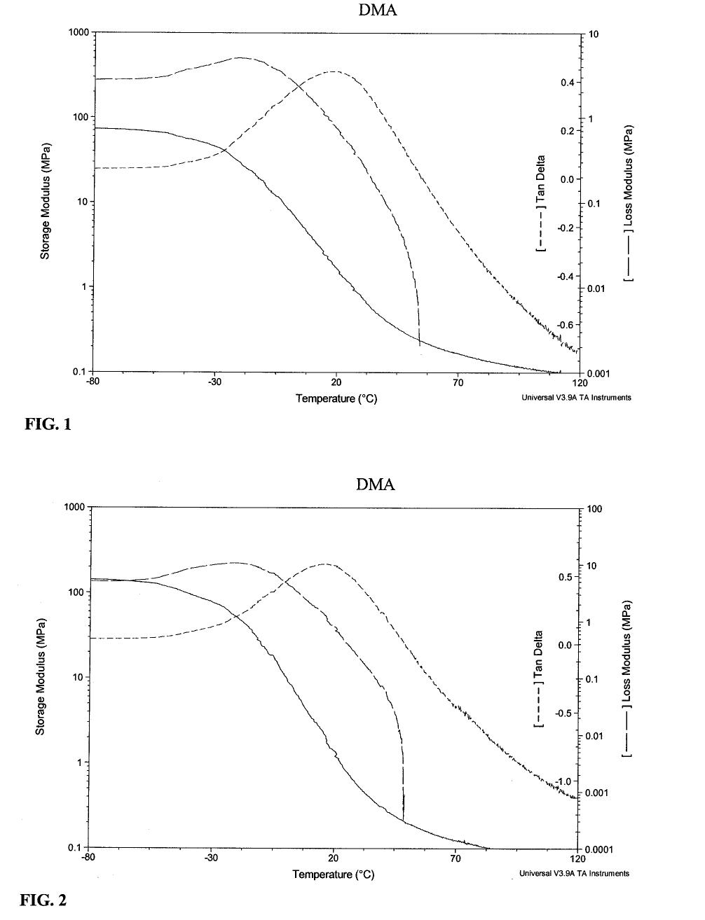

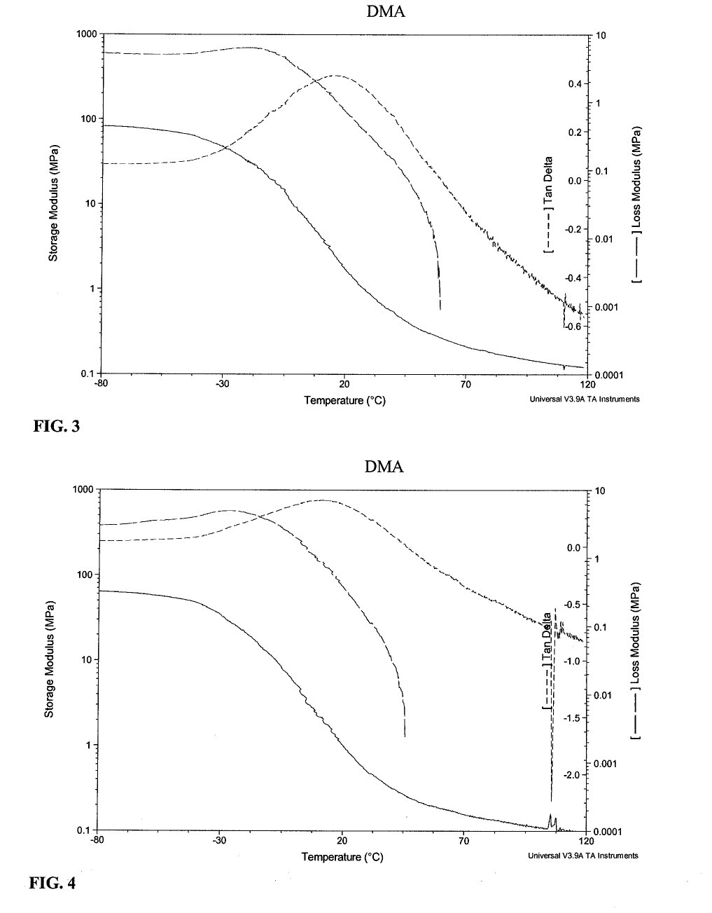

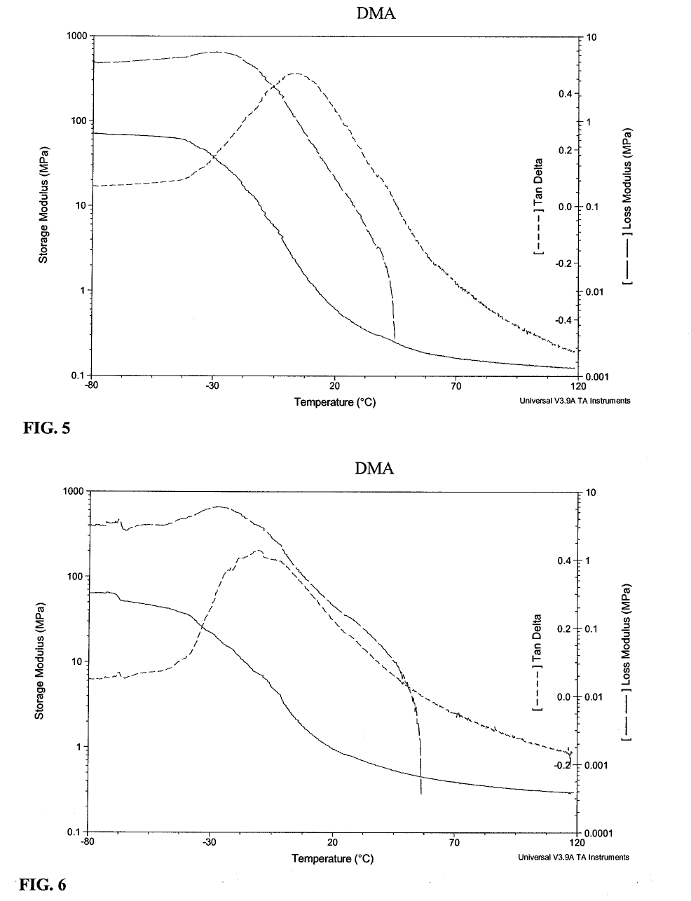

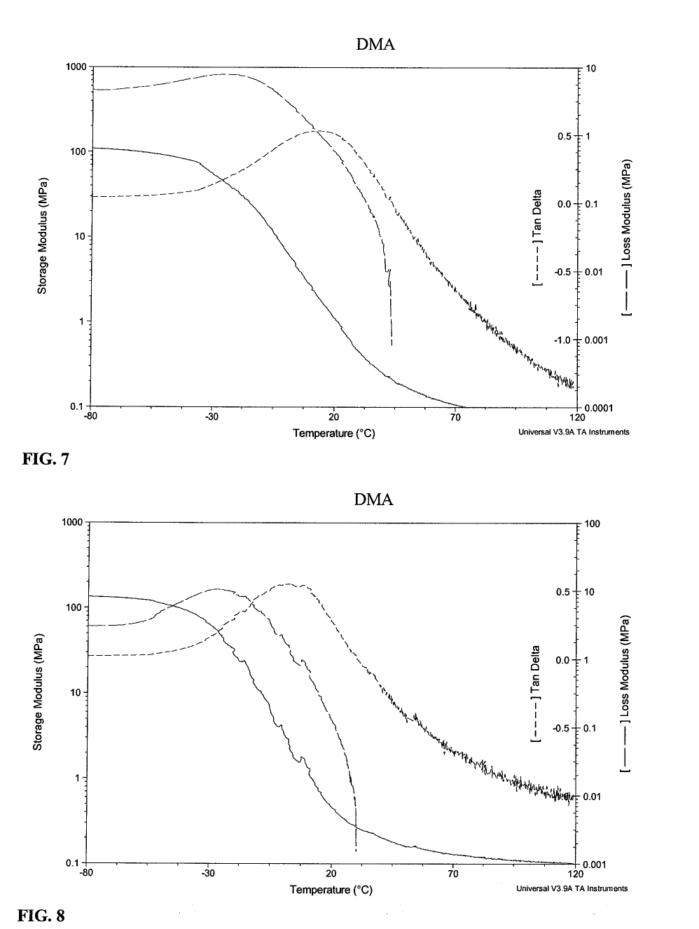

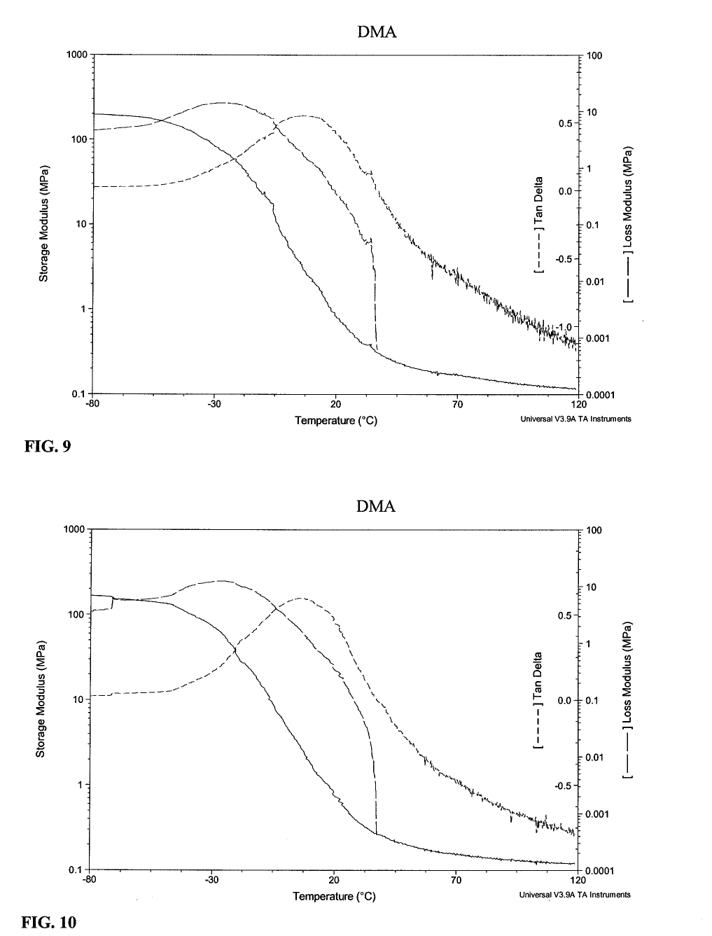

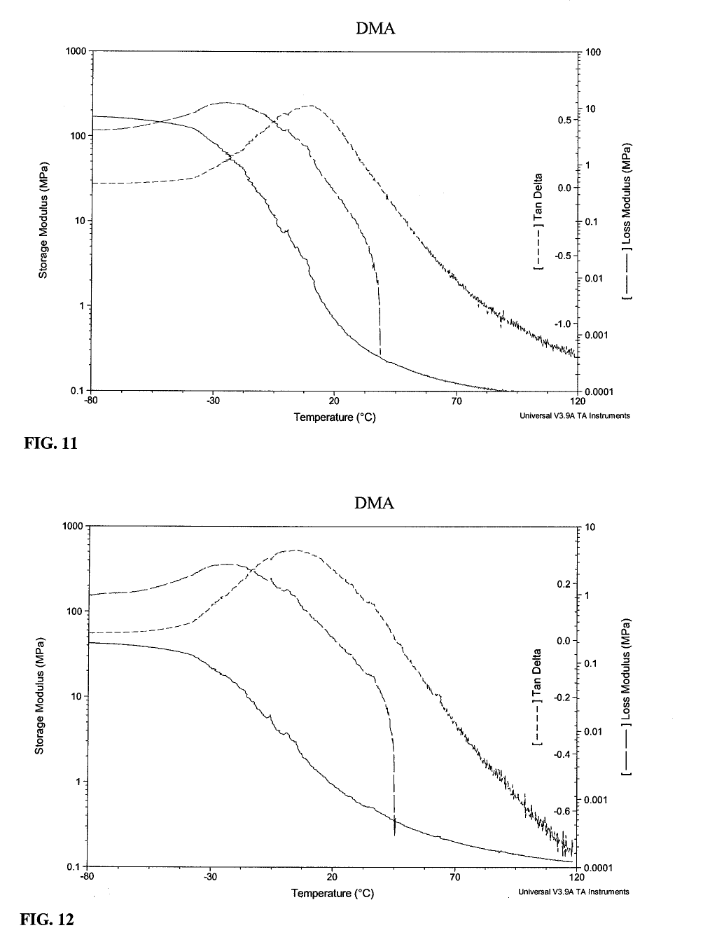

Dynamic mechanical analysis (DMA) was conducted on the polyurethane foams samples of Examples 1-4 in accordance with ASTM D4065 using Universal V3.9A TA instruments (model 2980) DMA V1.5B. The foams were tested from −80° C. to +120° C. at a frequency of 10 Hz and at 2.5° C./minute heating rate. The DMA curves are provided in FIGS. 1-13.

SUMMARY OF DMA SAMPLES

| | | Part of Water | | |
|---|---|---|---|---|
| | | used in | | |
| Sample I.D. | FIG. | formulation | Index | Description |
| 86 | 1 | 1.5 | 100 | 100% 1XS-306 |
| 87 | 2 | 1.0 | 100 | 100% 1XS-306 |
| 88 | 3 | 1.5 | 100 | 80% 1XS-306 + 20% 1XS- |
| | | | | 500 |
| 89 | 4 | 1.5 | 100 | 80% 1XS-306 + 20% 1XS- |
| | | | | 304 |
| 90 | 5 | 1.5 | 100 | 80% 1XS-306 + 20% F- |
| | | | | 3022 |
| 92 | 6 | 1.5 | 100 | 100% 1XS-304 |
| 97 | 7 | 1.5 | 90 | 100% 1XS-306 |
| 98 | 8 | 1.5 | 90 | 80% 1XS-306 + 20% F- |
| | | | | 3022 |
| 99 | 9 | 1.5 | 90 | 80% 1XS-306 + 20% 1XS- |
| | | | | 500 |
| 101 | 10 | 1.0 | 100 | 80% 1XS-306 + 20% F- |
| | | | | 3022 |
| 102 | 11 | 1.0 | 100 | 80% 1XS-306 + 20% 1XS- |
| | | | | 500 |
| 106 | 12 | 2.5 | 90 | 100% 1XS-306 |
| 108 | 13 | 1.5 | 90 | 100% 1XS-306 with MDI |
| | | | | (MRS-20) |

TABLE 6-1
DMA Data For Formulations with 1 Part Water and 100 index:

| | Sample I.D. | | |
|---|---|---|---|
| | 87 | 101 | 102 |
| Water usage | 1.0 | 1.0 | 1.0 |
| Natural Oil Polyol | 100% 1XS-306 | 80% 1XS-306 | 80% 1XS-306 |
| | | | 20% 1XS-500 |
| PET usage | 0 | 20% F-3022 | |
| Max SM, MPa | 142.7 | 167.32 | 168.98 |
| @ Temp, ° C. | −80 | −80 | −80 |
| Max LM, MPa | 10.62 | 12.373 | 12.373 |
| @ Temp, ° C. | −21.78 | −27.14 | −24.73 |
| Max Tan Delta, ° C., | 16.69 | 6.17 | 10.03 |
| @ SM, MPa | 0.588 | 0.598 | 0.601 |
| @ −30° C. | | | |
| SM | 77.74 | 72.73 | 82.12 |
| LM | 9.72 | 12.10 | 11.81 |
| @ 50° C. | | | |
| SM | 0.199 | 0.198 | 0.181 |
| LM | −0.00492 | −0.048 | −0.0517 |
| SM Ratio between | 390.7 | 367.3 | 453.7 |
| (−)30° C. thru 50° C. | | | |

TABLE 6-2
DMA Data For Formulations with 1.5 Part Water and 100 index:

| | Sample I.D. | | | | |
|---|---|---|---|---|---|
| | 86 | 92 | 88 | 89 | 90 |
| Water usage | 1.5 | 1.5 | 1.5 | 1.5 | 1.5 |
| Natural Oil Polyol | 100% | 100% | 80% 1XS- | 80% 1XS- | 80% 1XS- |
| | 1XS-306 | 1XS-304 | 306 | 306 | 306 |
| | | | 20% 1XS- | 20% 1XS- | |
| | | | 500 | 304 | |
| PET usage | 0 | 0 | | | 20% |
| | | | | | F-3022 |
| Max SM (MPa) | 73.45 | 65.1 | 82.21 | 63.89 | 70.478 |
| @ Temp, ° C. | −80 | −72.4 | −80 | −80 | −80 |
| Max LM, MPa | 5.07 | 6.02 | 6.399 | 4.958 | 6.549 |
| @ Temp, ° C. | −19.88 | −27.86 | −19.73 | −26.99 | −28.69 |
| Max Tan Delta, | 19.06 | −10.66 | 15.04 | 11.47 | 2.26 |
| ° C. | | | | | |
| @ SM (MPa) | 0.441 | 0.428 | 0.432 | 0.410 | 0.4697 |
| @ −30° C. | | | | | |
| SM | 45.23 | 23.397 | 48.108 | 34.445 | 37.64 |
| LM | 4.42 | 5.727 | 5.942 | 4.866 | 6.485 |
| @ 50° C. | | | | | |
| SM | 0.275 | 0.4937 | 0.355 | 0.232 | 0.216 |
| LM | 0.022 | 0.0151 | 0.0429 | −0.013 | −0.0161 |
| SM Ratio between | 164.5 | 47.39 | 135.5 | 148.5 | 174.2 |
| (−) 30° C. thru 50° C. | | | | | |
| LM Ratio between | 200.9 | 379.3 | 138.5 | | |
| (−) 30° C. thru 50° C. | | | | | |

SM = Storage Modulus
LM = Loss Modulus
Tan Delta = Ratio of LM over SM

TABLE 6-3
DMA Data For Formulations with 1.5 or 2.5 Parts Water @ 90 index

| | Sample I.D. | | | | |
|---|---|---|---|---|---|
| | 97 | 98 | 99 | 108 | 106 |
| Water usage | 1.5 | 1.5 | 1.5 | 1.5 | 2.5 |
| Natural Oil Polyol | 100% | 80% | 80% 1XS- | 100% | 100% |
| | 1XS-306 | 1XS-306 | 306 | 1XS-306 | 1XS-306 |
| | | | 20% 1XS- | | |
| | | | 500 | | |
| PET usage | 0 | 20% | 0 | 0 | 0 |
| | | F-3022 | | | |
| Max SM, MPa | 109.5 | 135.11 | 197.49 | 99.7 | 42.48 |
| @ Temp, ° C. | −80 | −80 | −80 | −80 | −80 |
| Max LM, MPa | 7.886 | 10.56 | 14.12 | 6.42 | 2.78 |
| @ Temp, ° C. | −25.93 | −27.12 | −26.46 | −12.45 | −26.96 |
| Max Tan Delta | 13.16 | 2.39 | 6.424 | 20.63 | 4.82 |
| ° C. | | | | | |
| @ SM, MPa | 0.532 | 0.551 | 0.554 | 0.577 | 0.318 |
| @ −30° C. | | | | | |
| SM | 55.21 | 65.633 | 82.25 | 62.02 | 22.08 |
| LM | 7.74 | 10.245 | 13.97 | 5.41 | 2.62 |
| @ 50° C. | | | | | |
| SM | 0.171 | 0.164 | 0.214 | 0.248 | 0.302 |
| LM | −0.033 | −0.0645 | −0.076 | 0.032 | −0.0175 |
| SM Ratio between | 322.87 | 400.2 | 384.3 | 250.08 | 73.11 |
| (−) 30° C. thru 50° C. | | | | | |
| LM Ratio between | | | | 169.06 | |
| (−) 30° C. thru 50° C. | | | | | |

SM = Storage Modulus
LM = Loss Modulus
Tan Delta = Ratio of LM over SM

### Example 7

### DMA Testing for Commercial Viscoelastic Foam Samples

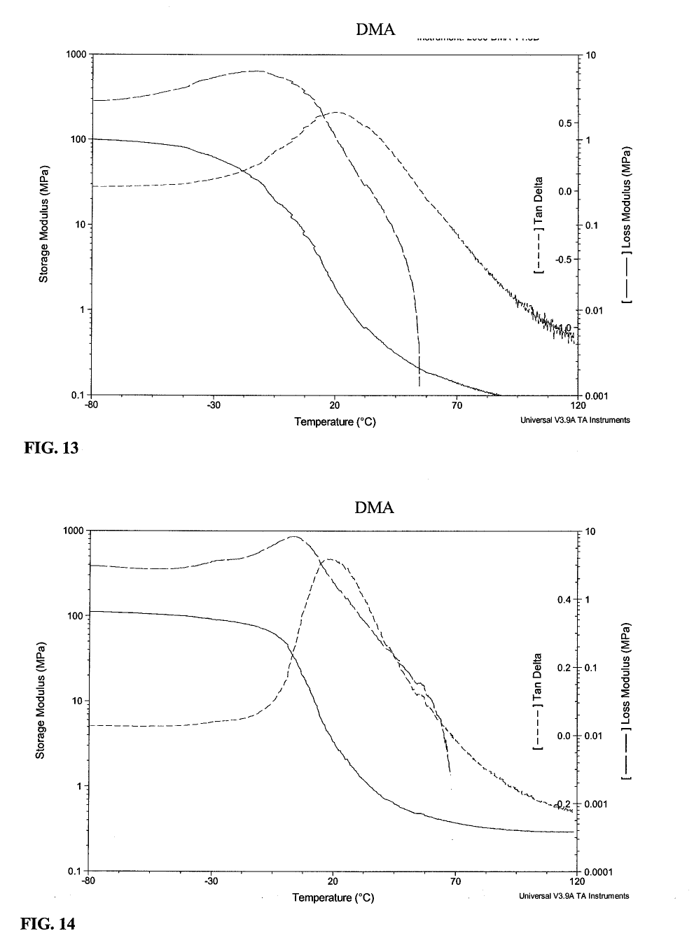

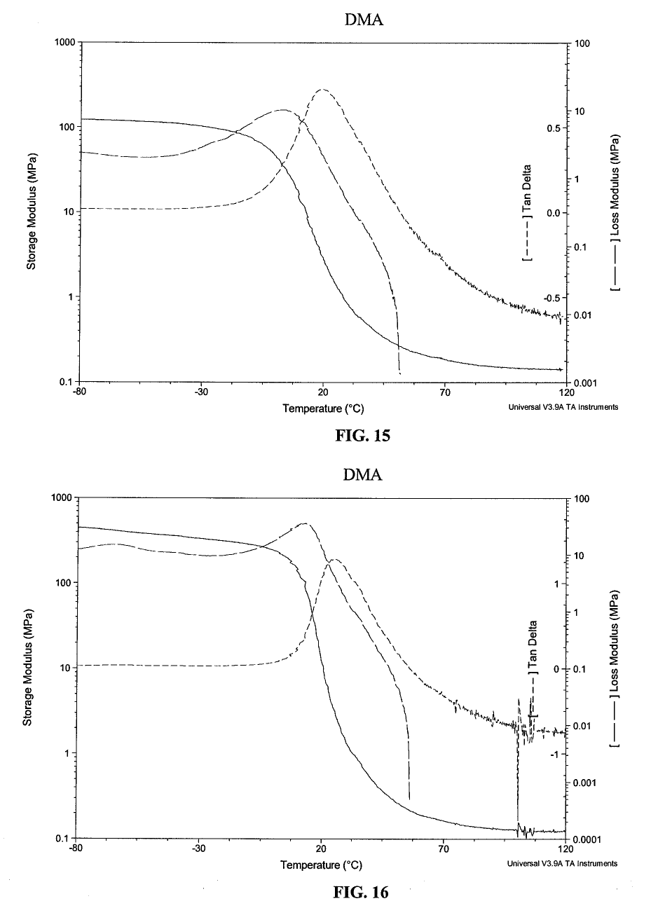

Dynamic mechanical analysis was conducted on commercially available viscoelastic polyurethane foam samples. The DMA curves are provided in FIGS. 14-16.

SUMMARY OF DMA TESTING

| Sample | | |
|---|---|---|
| I.D. | FIG. | Description |
| 10-1 | 14 | Commercial Viscofoam |
| 10-2 | 15 | Commercial Viscofoam |
| 10-3 | 16 | Commercial Viscofoam |

TABLE 7-1
DMA Data For Commercial VE Foam Samples

| | Sample I.D. | | |
|---|---|---|---|
| | 10-1 | 10-2 | 10-3 |
| Foam Density | 2.5 | 3.5 | 5.0 |
| (lbs/ft³) | | | |
| Max SM (MPa) | 111.9 | 122.6 | 446.5 |
| @ Temp (° C.) | −80 | −80 | −80 |
| Max LM (MPa) | 8.34 | 10.27 | 36.13 |
| @ Temp, (° C.) | 3.41 | 2.85 | 13.31 |
| Max Tan Delta | 17.2 | 18.79 | 25.01 |
| (° C.) | 0.517 | 0.726 | 1.286 |
| @ SM (MPa) | | | |
| @ −30° C. | | | |
| SM | 91.56 | 103.2 | 334.32 |
| LM | 3.58 | 2.896 | 9.735 |
| @ 50° C. | | | |
| SM | 0.534 | 0.286 | 0.281 |
| LM | 0.0893 | 0.0135 | 0.062 |
| SM Ratio between | 171.46 | 260.84 | 1189.75 |
| (−) 30° C. thru 50° C. | | | |
| LM Ratio between | 40.09 | 214.52 | 157.02 |
| (−) 30° C. thru 50° C. | | | |

SM = Storage Modulus
LM = Loss Modulus
Tan Delta = Ratio of LM over SM

### Example 7

Example 7 describes the production and testing of viscoelastic foam samples prepared using Polyol 1XS-308 as compared to a control formulation.

Foam Preparation Procedure:

All components were added in the order shown in TABLE 7.1. The polyols, silicone, water, and amine were added into a cup and premixed using a lab mixer at 2000 rpm for 30 seconds, and then a pre-weighted amount of tin catalyst was added under continuous mixing for 5 seconds. Subsequently, the correct amount of TDI was added under continuous mixing for 7 seconds and the mixture was poured into a paper cake box (8×8×4 inches) where it rose freely until the reaction was completed.

TABLE 7.1
Typical Foam Formulation

| | pph | Mixing steps @ 2000 rpm |
|---|---|---|
| Polyol | 100-80 | Mixture add and mix for 30 |
| Co-Polymer Polyol | 0-20 | seconds |
| Flame Retardant | 0-4 | |
| Surfactant | 0-1 | |
| Amine | 0-0.5 | |
| Water | 0-2.3 | |
| Tin | 0-0.5 | Add Tin and mix for 5 |
| | | seconds |
| 80/20 T80 | | Add TDI and mix for 10 |
| Index | 0.8-1.0 | seconds |

Foam rise equipment (FOAMAT) was also used to record the foam reaction profile. The freshly prepared foam was cured for 10 minutes in an oven at 100° C. and then allowed to cure at ambient conditions for a minimum of 7 days. The samples were then conditioned for at least 16 hours at standard temperature (23° C.±1° C.) and humidity (50%±1%) before testing. The foams were then trimmed to 6×6×3 inches to perform density, ball rebound, and foam hardness tests. These blocks of foam were rested at least 16 hours before conducting the recovery test. After the recovery test, these blocks of foam were allowed to rest for at least 16 hours before being cut for DMA, tensile, elongation, tear, airflow, and compression set tests.

Tables 7-2 and 7-3 provide the foam formulations tested.

TABLE 7-2
Foam Formulations (2.3 Parts of Water)

| Sample I.D. | Control | Exp #1 | Exp #2 |
|---|---|---|---|
| 1XS-308 Polyol | | 80 | 100 |
| Conventional visco polyol | 80 | | |
| Co-polymer polyol | 20 | 20 | |
| Flame Retardant | 3 | 3 | 3 |
| Water | 2 | 2.3 | 2.3 |
| Surfactant | 1 | 0.1 | 0.3 |
| Amine | 0.2 | 0 | 0 |
| Tin (T9) | 0.05 | 0.3 | 0.35 |
| Index | 70 | 80 | 80 |
| Blow off | YES | YES | YES |
| Settle (%) | 0.38 | 0.44 | 0.95 |
| Max Temp (° F.) | 181.2 | 151.7 | 160.3 |
| Max time (sec) | 298 | 292 | 209 |
| Foam bun height (inches) | 5.33 | 4.56 | 5.28 |

TABLE 7-3
Foam Formulations (1.3 Parts of Water)

| Sample I.D. | Control | Exp #1 | Exp #2 | Exp #3 |
|---|---|---|---|---|
| 1XS-308 Polyol | | 80 | 80 | 100 |
| Conventional Visco Polyol | 80 | | | |
| Conventional Polyol | | | 20 | |
| Co-polymer Polyol | 20 | 20 | | |
| Flame Retardant | 3 | 3 | 3 | 3 |
| Water | 1.2 | 1.3 | 1.3 | 1.3 |
| Surfactant | 1 | 0.54 | 0.04 | 1.04 |
| Amine | 0.5 | 0.4 | 0.2 | 0.5 |
| Tin (T9) | 0.05 | 0.4 | 0.5 | 0.5 |
| Index | 70 | 100 | 100 | 100 |
| Blow off | YES | NO | NO | NO |
| Settle (%) | 1.63 | 0.2 | 0.77 | 1.78 |
| Max Temp (° F.) | 208.7 | 161.5 | 164.5 | 164.7 |
| Max time (sec) | 216 | 169 | 191 | 186 |
| Foam bun height (inches) | 4.92 | 5.0 | 5.2 | 5.07 |

Foam Testing

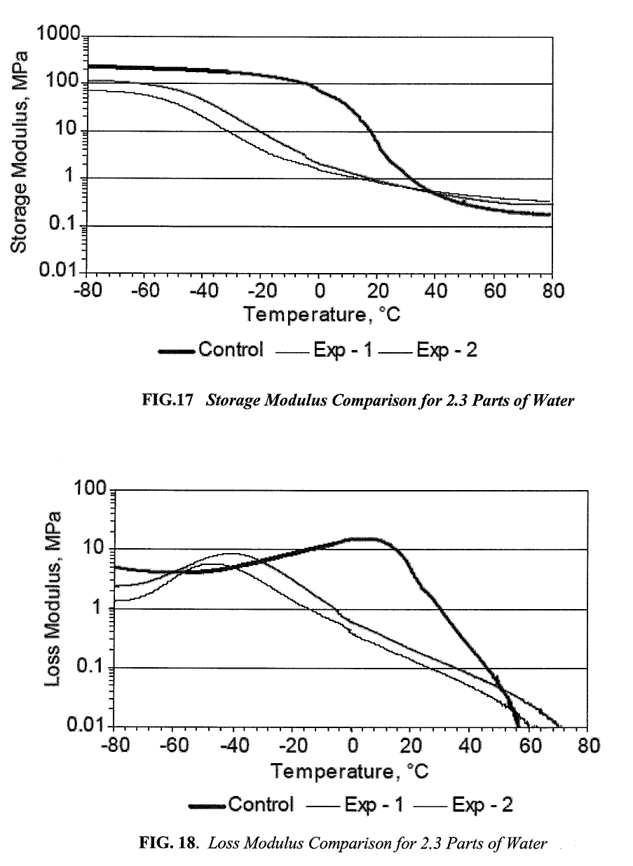

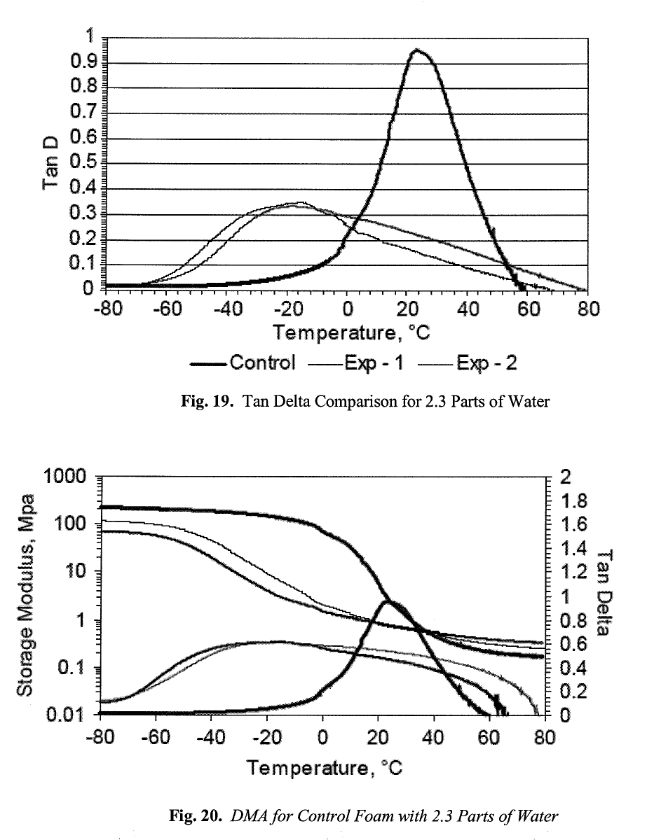

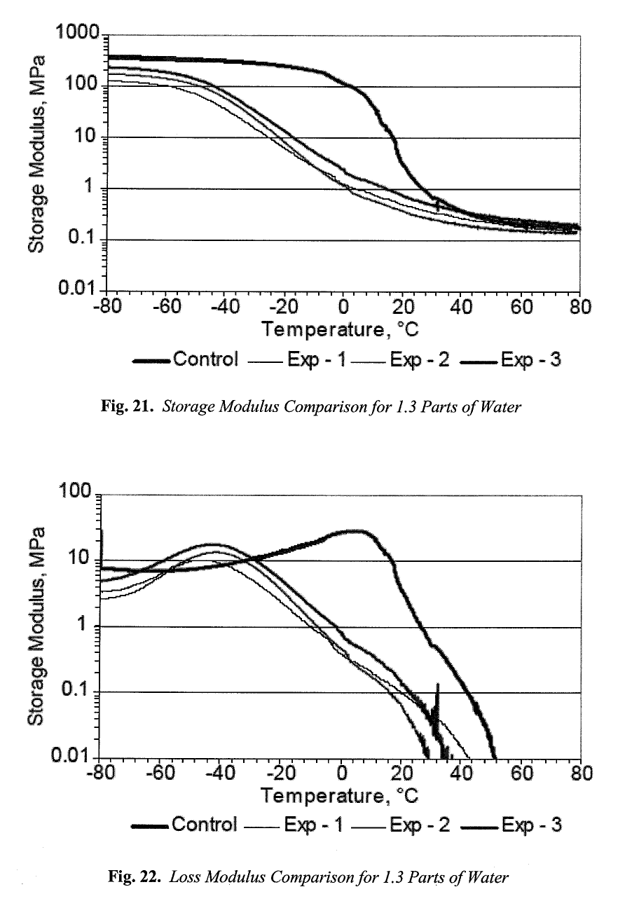

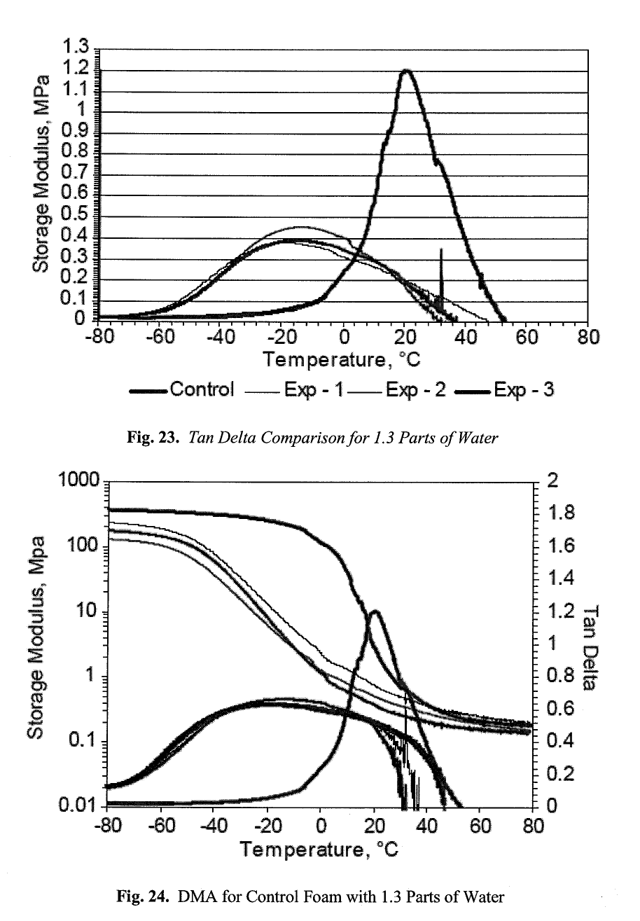

An Instron machine (model 5567) was used to perform physical property testing according to ASTM D3574. Dynamic Mechanical Analysis was used to characterize the damping performance (Tan Delta), energy absorption (Loss Modulus), and hard-segment morphology (Storage Modulus) of all viscoelastic foam for this work. Dynamic Mechanical Analysis (DMA) was performed according to ASTM D4065 using Universal V3.9A TA instruments (model 2980) DMA V1.5B. The foams were tested from −80° C. to +80° C. at a frequency of 10 Hz and at 2.5° C./min heating rate. The physical property testing and DMA testing results are shown in TABLES 7-4 to 7-7, and in FIGS. 17-24.

TABLE 7-4
Summary of DMA Data for Foam Formulations (2.3 Parts of Water)

| Sample I.D. | Control | Exp #1 | Exp #2 |
|---|---|---|---|
| Max Storage Modulus (MPa) | 222.72 | 71.31 | 116.09 |
| @ Temp ° C. | −80.07 | −80.01 | −79.8 |
| Max Loss Modulus (MPa) | 15.63 | 5.76 | 8.58 |
| @ Temp ° C. | 4.88 | −46.63 | −40.76 |
| Max Tan Delta (° C.) | 23.17 | −15.2 | −17.77 |
| Max Tan Delta ratio | 0.956 | 0.3515 | 0.3363 |
| Storage Modulus @ −40° C. | 189.39 | 20.08 | 45.26 |
| Loss Modulus @ −40° C. | 4.98 | 4.986 | 8.56 |
| Tan Delta @ −40° C. | 0.026 | 0.248 | 0.189 |
| Storage Modulus @ +40° C. | 0.4757 | 0.5446 | 0.497 |
| Loss Modulus @ +40° C. | 0.2352 | 0.0493 | 0.0803 |
| Tan Delta @ +40° C. | 0.494 | 0.0906 | 0.1615 |
| Storage Modulus Ratio, | 0.0025 | 0.0271 | 0.0110 |
| +40° C./−40° C. | | | |
| Loss Modulus Ratio, +40° C./−40° C. | 0.0472 | 0.0099 | 0.0094 |
| Tan Delta Ratio, +40° C./−40° C. | 19.0000 | 0.3653 | 0.8545 |

SM = Storage Modulus
LM = Loss Modulus
Tan Delta = Ratio of LM over SM

TABLE 7-5
Summary of DMA Data for Foam Samples (1.3 Parts of Water)

| Sample I.D. | Control | Exp #1 | Exp #2 | Exp#3 |
|---|---|---|---|---|
| Max SM | 366.71 | 127.55 | 111.75 | 235.5 |
| @ Temp ° C. | −79.96 | −80.01 | −79.99 | −80.01 |
| Max LM | 28.36 | 10.14 | 7.07 | 17.63 |
| @ Temp ° C. | 4.84 | −46.17 | −38.05 | −42.68 |
| Max Tan Delta (° C.) | 20.71 | −17.96 | −13.58 | −15.45 |
| Max Tan Delta Ratio | 1.2038 | 0.3789 | 0.454 | 0.3899 |
| Storage Modulus | 314.395 | 36.611 | 55.88 | 78.7388 |
| @ −40° C. | | | | |
| Loss Modulus | 8.472 | 9.059 | 6.951 | 17.204 |
| @ −40° C. | | | | |
| Tan Delta @ −40° C. | 0.02695 | 0.2475 | 0.1244 | 0.2185 |
| Storage Modulus | 0.3813 | 0.2766 | 0.663 | 0.36778 |
| @ +40° C. | | | | |
| Loss Modulus | 0.1498 | 0.0174 | 0.1025 | 0.0177 |
| @ +40° C. | | | | |
| Tan Delta @ +40° C. | 0.393 | 0.0627 | 0.1546 | 0.04804 |
| Storage Modulus | 0.0012 | 0.0076 | 0.0119 | 0.0047 |
| Ratio, +40° C./−40° C. | | | | |
| Loss Modulus | 0.0177 | 0.0019 | 0.0147 | 0.0010 |
| Ratio, +40° C./−40° C. | | | | |
| Tan Delta | 14.5826 | 0.2533 | 1.2428 | 0.2199 |
| Ratio, +40° C./−40° C. | | | | |

SM = Storage Modulus
LM = Loss Modulus
Tan Delta = Ratio of LM over SM

TABLE 7-6
Physical Properties of Foam Samples (2.3 Parts of Water)

| | | | | Test Procedure |
|---|---|---|---|---|
| Sample I.D. | Control | Exp #1 | Exp #2 | ASTM 3574 |
| Density (kg/m³) | 50.45 | 49.17 | 44.05 | A |
| Resilience (%) | 0 | 13.7 | 9.7 | H |
| 25% IFD (N) | 12.98 | 39.72 | 22.48 | B1 (6 × 6 × 3 inches) |
| 65% IFD (N) | 41.43 | 78.14 | 51.73 | B1 (6 × 6 × 3 inches) |
| 25% IFD Return** | 8.65 | 28.66 | 15.45 | B1 (6 × 6 × 3 inches) |
| 65/25 IFD Ratio | 3.19 | 1.97 | 2.3 | |
| Hysteresis (%)*** | 66.64 | 72.16 | 68.73 | |
| Tensile (Kpa) | 74.03 | 52.6 | 32.39 | E |
| Elongation (%) | 257.59 | 83.77 | 68.67 | E (auto grips) |
| Tear (N/m) | 236.67 | 126.67 | 76.67 | F |
| Airflow (SCFM) | 0 | 0 | 0 | G |
| 50% CS (%) | 21.55 | 51.82 | 59.99 | D |
| Recovery | 94 | 0 | 0 | |
| time (sec)* | | | | |

*For recovery time, 6 × 6 × 3 inch foam samples were compressed to 25% of the height at rate of 50 mm/minute using a 6″ diameter foot. They were then held under this compression rate for 1 minute. After the hold period, the foot was released at a rate of 500 mm/min. The time from the beginning of the release until the sample contacted the foot (100% recovery) was recorded in seconds.
**25% IFD Return was determined in accordance with ASTM 3574 (B1), except that after measuring the 65% IFD in accordance with the test (See, Section 20.3), the deflection is decreased to 25% and the force is allowed to drift while maintaining the 25% deflection. The force is then measured after 60 ± 3 seconds, and is reported as Return 25% IFD.
***% Hysteresis = (Return 25% IFD Value/Original 25% IFD Value) * 100%. Original 25% IFD may be measured in accordance with ASTM 3574(B1).

TABLE 7-7
Physical Properties of Foam Samples (1.3 Parts of Water)

| | | | | | Test Procedure |
|---|---|---|---|---|---|
| | Control | Exp #1 | Exp #2 | Exp #3 | ASTM 3574 |
| Density (kg/m³) | 75.44 | 56.06 | 53.99 | 57.50 | A |
| Resilience (%) | 0 | 17 | 13 | 9.33 | H |
| 25% IFD (N) | 22 | 25.24 | 13.29 | 15.81 | B1 (6 × 6 × 3 inches) |
| 65% IFD (N) | 57.25 | 56.93 | 33.03 | 34.41 | B1 (6 × 6 × 3 inches) |
| 25% IFD Return | 18.16 | 20.55 | 11.26 | 12.64 | B1 (6 × 6 × 3 inches) |
| (N)** | | | | | |
| 65/25 IFD Ratio | 2.6 | 2.26 | 2.49 | 2.18 | |
| Hysteresis | 82.55 | 81.42 | 84.73 | 79.95 | |
| (%)*** | | | | | |
| Tensile (Kpa) | 69.72 | 56.99 | 32.14 | 35.38 | E |
| Elongation (%) | 208.05 | 123.04 | 102.89 | 92.93 | E (auto grips) |
| Tear (N/m) | 193.33 | 176.67 | 90 | 103.33 | F |
| Airflow (SCFM) | 0 | 1.11 | 0.72 | 0.83 | G |
| 50% CS (%) | 6.87 | 22.8 | 38.46 | 35.55 | D |
| Recovery time* | 30 | 0 | 6 | 13 | |
| (sec) | | | | | |

*For recovery time, 6 × 6 × 3 inch foam samples were compressed to 25% of the height at rate of 50 mm/minute using a 6″ diameter foot. They were then held under this compression rate for 1 minute. After the hold period, the foot was released at a rate of 500 mm/min. The time from the beginning of the release until the sample contacted the foot (100% recovery) was recorded in seconds.
**25% IFD Return was determined in accordance with ASTM 3574 (B1), except that after measuring the 65% IFD in accordance with the test (See, Section 20.3), the deflection is decreased to 25% and the force is allowed to drift while maintaining the 25% deflection. The force is then measured after 60 ± 3 seconds, and is reported as Return 25% IFD.
***% Hysteresis = (Return 25% IFD Value/Original 25% IFD Value) * 100%. Original 25% IFD may be measured in accordance with ASTM 3574(B1).

### Example 8

Synthesis of Polyols from Chemically Oligomerized Soybean Oil.

Example 8-1: X-500, a polyol made from polymerization of an epoxidized soybean oil (1000 g, OH# 56.1 mg KOH/g, from Cargill), Polyethylene glycol (90.5 g, 380-420 MW, 285 OH#, from Dow) and Fascat 4350 catalyst (1.09 g) were placed in a 3-necked, 2-liter round-bottom flask equipped with a stirrer, thermocouple, and heating mantle, under a nitrogen atmosphere. The reaction mixture was heated to 180° C. with stirring and held for 5 hours, and then allowed to cool to room temperature. The final product was a clear, pale yellow liquid having the properties listed below.

| Property | Value | |
|---|---|---|
| OH Number | 75.8 | mg KOH/g |
| Viscosity | 5.78 | Pa · s at 25° C. |
| Mn (GPC) | 1706 | |
| Mw (GPC) | 5081 | |
| Fn (GPC) | 2.30 | |
| Fw (GPC) | 6.86 | |

Example 8-2: X-500, a polyol made from polymerization of an epoxidized soybean oil (1000 g, OH# 56.1 mg KOH/g, from Cargill), Polyethylene glycol (205.3 g, 380-420 MW, 285 OH#, from Dow) and Fascat 4350 catalyst (1.21 g) were placed in a 3-necked, 2-liter round-bottom flask equipped with a stirrer, thermocouple, and heating mantle, under a nitrogen atmosphere. The reaction mixture was heated to 180° C. with stirring and held for 5 hours, and then allowed to cool to room temperature. The final product was a clear, pale yellow liquid having the properties listed below.

| Property | Value | |
|---|---|---|
| OH Number | 94.7 | mg KOH/g |
| Viscosity | 3.39 | Pa · s at 25° C. |
| Mn (GPC) | 1495 | |
| Mw (GPC) | 3783 | |
| Fn (GPC) | 2.52 | |
| Fw (GPC) | 6.38 | |

Example 8-3: X-500, a polyol made from polymerization of an epoxidized soybean oil (100 g, OH# 56.1 mg KOH/g, from Cargill), Jeffamine D-400 (9.15 g, 428 MW, 2 amino groups/molecule, from Huntsman) and Fascat 4350 catalyst (0.22 g) were placed in a 3-necked, 250 mL round-bottom flask equipped with a stirrer, thermocouple, and heating mantle, under a nitrogen atmosphere. The reaction mixture was heated to 170° C. with stirring and held for 6 hours, and then allowed to cool to room temperature. The final product was a very viscous, dark brown liquid having the properties listed below.

| Property | Value | |
|---|---|---|
| OH Number | 93.8 | mg KOH/g |
| Amine Value | 4.6 | mg KOH/g |
| Viscosity | 194 | Pa · s at 25° C. |
| Mn (GPC) | 1729 | |
| Mw (GPC) | 3707 | |
| Fn (GPC) | 2.88 | |
| Fw (GPC) | 6.20 | |

Example 8-4: X-500, a polyol made from polymerization of an epoxidized soybean oil (100 g, OH# 56.1 mg KOH/g, from Cargill), Jeffamine D-400 (4.58 g, 428 MW, 2 amino groups/molecule, from Huntsman) and Fascat 4350 catalyst (0.21 g) were placed in a 3-necked, 250 mL round-bottom flask equipped with a stirrer, thermocouple, and heating mantle, under a nitrogen atmosphere. The reaction mixture was heated to 170° C. with stirring and held for 7 hours, and then allowed to cool to room temperature. The final product was a very viscous, dark brown liquid having the properties listed below.

| Property | Value | |
|---|---|---|
| OH Number | 88.9 | mg KOH/g |
| Amine Value | 5.1 | mg KOH/g |
| Viscosity | 31 | Pa · s at 25° C. |
| Mn (GPC) | 1815 | |
| Mw (GPC) | 4132 | |
| Fn (GPC) | 2.88 | |
| Fw (GPC) | 6.55 | |

### Example 9

Synthesis of Polyols from Thermally Oligomerized Soybean Oil

Heat Bodied soybean oil (1624 g, 5 OH#, from Cargill), Polyethylene Glycol (531 g, 380-420 MW, 285 OH#, from Dow) and Fascat 4350 catalyst (2.1 g) were placed in a 5-liter glass reactor equipped with a stirrer, thermocouple, heating mantle, and a nitrogen sweep. The reaction mixture was heated to 170° C. with stirring and held for 3 hours, during which time the acid value decreased from 3.9 to 0.96 mg KOH/g. The reaction was stirred one more hour at 170° C., and allowed to cool to room temperature. The final product was clear and required no filtration. The polyol had the properties listed below.

| Property | Value |
|---|---|
| OH Number | 68.7 mg KOH/g |
| Acid Value | 0.82 mg KOH/g |
| Viscosity | 1298 cP at 25° C. |
| Water | 319 ppm |
| Color (Gardner) | 5.5 |
| Peroxide Value | 0 meq/1000 g |
| Mn (GPC) | 1106 |
| Mw (GPC) | 3153 |
| Fn (GPC) | 1.35 |
| Fw (GPC) | 6.20 |

Other embodiments of this invention will be apparent to those skilled in the art upon consideration of this specification or from practice of the invention disclosed herein. Variations on the embodiments described herein will become apparent to those of skill in the relevant arts upon reading this description. The inventors expect those of skill to use such variations as appropriate, and intend to the invention to be practiced otherwise than specifically described herein. Accordingly, the invention includes all modifications and equivalents of the subject matter recited in the claims as permitted by applicable law. All patents, patent documents, and publications cited herein are hereby incorporated by reference as if individually incorporated. In case of conflict, the present specification, including definitions, will control.

1. A viscoelastic polyurethane foam comprising the reaction product of:
(a) a polyisocyanate; and
(b) an active-hydrogen composition comprising an amidated or transesterified oligomeric natural oil polyol.

2. The viscoelastic polyurethane foam of claim 1, wherein the amidated or transesterified oligomeric natural oil polyol is made by the process of:
(a) providing a natural oil;
(b) chemically or thermally oligomerizing the natural oil to form an oligomeric natural oil; and
(c) amidating the oligomeric natural oil with a polyamine to form an amidated oligomeric natural oil polyol; or transesterifying the oligomeric natural oil with a polyol to form an transesterified oligomeric natural oil polyol.

3. The viscoelastic polyurethane foam of claim 1, wherein the active-hydrogen composition comprises an amidated oligomeric natural oil polyol.

4. The viscoelastic polyurethane foam of claim 3, wherein the amidated oligomeric natural oil polyol is chemically oligomerized.

5. The viscoelastic polyurethane foam of claim 4, wherein the chemical oligomerization results from ring-opening of an epoxidized natural oil.

6. The viscoelastic polyurethane foam of claim 3, wherein the amidated oligomeric natural oil polyol is thermally oligomerized.

7-16. (canceled)

17. The viscoelastic polyurethane foam of claim 2, wherein the polyamine is has the formula:
H₂H—R—NH₂
where R is an aliphatic group or aromatic group.

18. The viscoelastic polyurethane foam of claim 2, wherein the polyamine is a polyalkylene glycol diamine.

19. The viscoelastic polyurethane foam of claim 2, wherein the polyamine compound is a polybutylene glycol diamine, a polypropylene glycol diamine, a polyethylene glycol diamine, other polyalkylene glycol diamines, and mixtures thereof.

20. The viscoelastic polyurethane foam of claim 2, wherein the polyamine compound is an amine-terminated polypropylene glycol diamine.

21. The viscoelastic polyurethane foam of claim 17, wherein the amine-terminated polypropylene glycol diamine is represented by the formula:
H₂N—[—CH(—CH₃)—CH₂—O—]ₓ—CH₂—CH(—CH₃)—NH₂
where x ranges from about 2 to about 70.

22. The viscoelastic polyurethane foam of claim 21, wherein the amine-terminated polypropylene glycol diamine has a molecular weight ranging from about 200 grams/mole to about 4000 grams/mole.

23. The viscoelastic polyurethane foam of claim 2, wherein the polyamine compound comprises a polyethylene glycol diamine.

24. The viscoelastic polyurethane foam of claim 18, wherein the polyalkylene glycol diamine is represented by the formula:
H₂N—CH(—CH₃)—CH₂—[—O—CH₂—CH(—CH₃)—]ₓ—[O—CH₂—CH₂—]_{y}—[—O—CH₂—CH(—CH₃)—]_{z}—NH₂
where y is about 2 to about 40;
(x+z) is about 1 to about 6; and
the molecular weight of the diamine ranges from about 200 to about 2000 grams/mole.

25. The viscoelastic polyurethane foam of claim 2, wherein the diamine compound is represented by the formula:
H₂N—(CH₂)ₓ—O—CH₂—CH₂—O—(CH₂)ₓ—NH₂
where x ranges from about 2 to 3; and
the molecular weight ranges from about 140 to about 180 grams/mole.

26-28. (canceled)

29. The viscoelastic polyurethane foam of claim 1, wherein the amidated or transesterified oligomeric natural oil polyol comprises about 10% to about 70% weight oligomers.

30. (canceled)

31. The viscoelastic polyurethane foam of claim 1, wherein the amidated or transesterified oligomeric natural oil polyol has a number average molecular weight (Mn) ranging from about 1,000 to about 5,000 grams/mole.

32. The viscoelastic polyurethane foam of claim 1, wherein the amidated or transesterified oligomeric natural oil polyol has a weight average molecular weight (Mw) ranging from about 2,000 to about 50,000 grams/mole.

33. The viscoelastic polyurethane foam of claim 1, wherein the amidated or transesterified oligomeric natural oil polyol has a viscosity ranging from about 500 to about 20,000 cP.

34-35. (canceled)

36. The viscoelastic polyurethane foam of claim 1, wherein the active-hydrogen composition comprises about 10% weight or greater amidated or transesterified oligomeric natural oil polyol.

37. The viscoelastic polyurethane foam of claim 1, wherein the active-hydrogen composition comprises about 30% weight or greater amidated or transesterified oligomeric natural oil polyol.

38. The viscoelastic polyurethane foam of claim 1, wherein the active-hydrogen composition further comprises a secondary polyol selected from natural oil-derived polyols, petroleum-derived polyols, and mixtures thereof.

39. (canceled)

40. The viscoelastic polyurethane foam of claim 38, wherein the natural oil-derived polyol comprises an epoxidized and ring-opened natural oil polyol.

41-42. (canceled)

43. The viscoelastic polyurethane foam of claim 1, wherein the foam has a density of from about 1.5 to about 6 lbs/ft³.

44. The viscoelastic polyurethane foam of claim 1, wherein the foam has a ball rebound value of about 20% or less.

45-46. (canceled)

47. The viscoelastic polyurethane foam of claim 1, wherein the foam has a glass transition temperature (Tg) ranging from about −40° C. to about +40° C.

48. The viscoelastic polyurethane foam of claim 1, wherein the foam has a storage modulus (G′) of 70 MPa or less at −30° C., when measured using dynamic mechanical analysis.

49. The viscoelastic polyurethane foam of claim 1, wherein the foam has a loss modulus (G″) of about 10 MPa or less at −30° C., when measured using dynamic mechanical analysis.

50. The viscoelastic polyurethane foam of claim 1, wherein the foam has a storage modulus ratio between −30° C. and 50° C. that is less than the storage modulus ratio between −30° C. and 50° C. that is obtained for a comparable viscoelastic foam prepared with a petroleum-derived polyol.

51-52. (canceled)

53. The viscoelastic polyurethane foam of claim 1, wherein the amidated or transesterified oligomeric natural oil polyol has a total odor level of hexanal, nonanal, and decanal of about 200 ppm or less when measured by GC headspace analysis.

54-55. (canceled)
